(19) United States
(12) Patent Application Publication
(10) Pub. No.: US 2025/0018769 A1
(43) Pub. Date: Jan. 16, 2025

(54) TEMPERATURE REGULATING DEVICE

(71) Applicant: DENSO CORPORATION, Kariya-city (JP)

(72) Inventors: Kohei Noguchi, Kariya-city (JP); Yasuhiro Yokoo, Kariya-city (JP); Yoshiki Kato, Kariya-city (JP); Yukihisa Ijuin, Kariya-city (JP); Hiroaki Kawano, Kariya-city (JP); Yoshio Hayashi, Kariya-city (JP); Junki Hirayama, Kariya-city (JP); Naito Muto, Kariya-city (JP)

(21) Appl. No.: 18/903,548

(22) Filed: Oct. 1, 2024

Related U.S. Application Data
(63) Continuation of application No. PCT/JP2023/010909, filed on Mar. 20, 2023.

(30) Foreign Application Priority Data
Apr. 12, 2022 (JP) 2022-065873

(51) Int. Cl. B60H 1/22; B60H 1/32; F25B 5/02; F25B 41/31

(52) U.S. Cl. CPC B60H 1/22; B60H 1/3204; F25B 5/02; F25B 41/31; B60H 2001/3286

(57) ABSTRACT

A refrigeration cycle includes a compressor, a refrigerant radiator, first and second expansion valves configured to decompress refrigerant flowing out of the refrigerant radiator, a first evaporator configured to evaporate the refrigerant flowing out of the first expansion valve, and a second evaporator configured to evaporate the refrigerant flowing out of the second expansion valve. A heat medium circuit includes a heat exchange portion and circulates a heat medium while flowing through the heat exchange portion and the second evaporator. The first evaporator exchanges heat between the refrigerant and ventilation air blown to a space to be air conditioned, and the second evaporator exchanges heat between the heat medium and the refrigerant to evaporate the refrigerant and cool the heat medium. The heat exchange portion is made to cool the temperature regulation target.

### CROSS REFERENCE TO RELATED APPLICATION

The present application is a continuation application of International Patent Application No. PCT/JP2023/010909 filed on Mar. 20, 2023, which designated the U.S. and claims the benefit of priority from Japanese Patent Application No. 2022-065873 filed on Apr. 12, 2022. The entire disclosures of all of the above applications are incorporated herein by reference.

### FIELD OF THE INVENTION

The present disclosure relates to a temperature regulating device for regulating a temperature of a temperature regulation target.

### BACKGROUND

In a vapor-compression refrigeration cycle, an evaporator cools ventilation air to be blown to a vehicle interior space.

In recent years, in vehicles such as electric vehicles, the number of temperature regulation targets to be cooled or heated tends to increase. Hence, there is a need to provide a temperature regulating device for regulating the temperature of the temperature regulation target with a simple configuration.

### SUMMARY

According to one aspect of the present disclosure, a temperature regulating device for regulating a temperature of a temperature regulation target includes a refrigeration cycle and a heat medium circuit. The refrigeration cycle includes a compressor configured to compress a refrigerant, a refrigerant radiator configured to radiate heat from the refrigerant flowing out of the compressor, a first expansion valve configured to decompress the refrigerant flowing out of the refrigerant radiator, a first evaporator configured to evaporate the refrigerant flowing out of the first expansion valve and to cause the refrigerant to flow to the compressor, a second expansion valve configured to decompress the refrigerant flowing out of the refrigerant radiator, and a second evaporator configured to evaporate the refrigerant flowing out of the second expansion valve and to cause the refrigerant to flow to the compressor.

The heat medium circuit includes a heat exchange portion and in which a heat medium circulates while flowing through the heat exchange portion and the second evaporator. The first evaporator exchanges heat between the refrigerant and ventilation air blown to a space to be air conditioned, to evaporate the refrigerant and cool the ventilation air. The second evaporator exchanges heat between the heat medium and the refrigerant, to evaporate the refrigerant and cool the heat medium. Furthermore, the heat exchange portion exchanges heat between the temperature regulation target and the heat medium, to cool the temperature regulation target.

According to another aspect of the present disclosure, a temperature regulating device for regulating a temperature of a temperature regulation target includes a refrigeration cycle and a heat medium circuit. The refrigeration cycle includes a compressor configured to compress a refrigerant, a refrigerant radiator configured to radiate heat from the refrigerant flowing out of the compressor, an expansion valve configured to decompress the refrigerant flowing out of the refrigerant radiator, and an evaporator configured to evaporate the refrigerant flowing out of the expansion valve and to cause the refrigerant to flow to the compressor.

The heat medium circuit includes a heat exchange portion, a heat medium radiator, and a flow rate adjustment mechanism. In the heat medium circuit, a heat medium circulates while flowing through the refrigerant radiator and at least one of the heat exchange portion or the heat medium radiator. The flow rate adjustment mechanism adjusts a flow rate ratio between a flow rate of the heat medium flowing through the heat exchange portion and a flow rate of the heat medium flowing through the heat medium radiator. The evaporator exchanges heat between the refrigerant and ventilation air blown to the space to be air conditioned, to evaporate the refrigerant and cool the ventilation air. The refrigerant radiator exchanges heat between the heat medium and the refrigerant, to heat the heat medium. The heat medium radiator radiates heat from the heat medium. In addition, the heat exchange portion exchanges heat between the temperature regulation target and the heat medium, to heat the temperature regulation target.

### BRIEF DESCRIPTION OF DRAWINGS

The above and other objects, features and advantages of the present disclosure will become more apparent from the following detailed description made with reference to the accompanying drawings. In the drawings:

FIG. 1 is a fluid circuit diagram illustrating a circuit configuration of a temperature regulating device in a first embodiment;

FIG. 2 is a diagram schematically illustrating a vehicle on which a temperature regulating device is installed in the first embodiment;

FIG. 3 is a block diagram illustrating connection devices electrically connected to a circuit controller of the temperature regulating device in the first embodiment;

FIG. 4 is a fluid circuit diagram illustrating a circuit configuration of a temperature regulating device in a second embodiment, and is a diagram corresponding to FIG. 1;

FIG. 5 is a schematic diagram illustrating a state where a temperature regulation target is placed on a heat exchange plate in the second embodiment;

FIG. 6 is a fluid circuit diagram illustrating a circuit configuration of a temperature regulating device in a third embodiment, and is a diagram corresponding to FIG. 1;

FIG. 7 is a fluid circuit diagram illustrating a circuit configuration of a temperature regulating device in a fourth embodiment, and is a diagram corresponding to FIG. 1;

FIG. 8 is a fluid circuit diagram illustrating a circuit configuration of a temperature regulating device in a fifth embodiment, and is a diagram corresponding to FIG. 1;

FIG. 9 is a fluid circuit diagram illustrating a circuit configuration of a temperature regulating device in a sixth embodiment, and is a diagram corresponding to FIG. 1;

FIG. 10 is a view schematically illustrating a temperature regulation space into which temperature-regulation target air is introduced from an air heat exchanger in the sixth embodiment;

FIG. 11 is a fluid circuit diagram illustrating a circuit configuration of a temperature regulating device in a seventh embodiment, and is a diagram corresponding to FIG. 1;

FIG. 12 is a fluid circuit diagram illustrating a circuit configuration of a temperature regulating device in an eighth embodiment, and is a diagram corresponding to FIG. 1;

FIG. 13 is a fluid circuit diagram illustrating a circuit configuration of a temperature regulating device in a ninth embodiment, and is a diagram corresponding to FIG. 1;

FIG. 14 is a diagram schematically illustrating a vehicle in which a temperature regulating device in a tenth embodiment is installed, and is a diagram corresponding to FIG. 2; and

FIG. 15 is a fluid circuit diagram illustrating a circuit configuration of a temperature regulating device in a modification of the first embodiment, and is a diagram corresponding to FIG. 1.

### DESCRIPTION OF EMBODIMENTS

The inventors of the present disclosure deeply studied to simplify the configuration of a temperature regulating device by using an air-conditioning refrigeration cycle. As a result of detailed studies by the inventors of the present disclosure, the following features and the like have been found.

An object of the present disclosure is to provide a temperature regulating device with a simple configuration capable of cooling or heating a temperature regulation target using an air-conditioning refrigeration cycle.

To achieve the above object, according to one aspect of the present disclosure, a temperature regulating device for regulating a temperature of a temperature regulation target includes a refrigeration cycle and a heat medium circuit. The refrigeration cycle includes a compressor configured to compress a refrigerant, a refrigerant radiator configured to radiate heat from the refrigerant flowing out of the compressor, a first expansion valve configured to decompress the refrigerant flowing out of the refrigerant radiator, a first evaporator configured to evaporate the refrigerant flowing out of the first expansion valve and to cause the refrigerant to flow to the compressor, a second expansion valve configured to decompress the refrigerant flowing out of the refrigerant radiator, and a second evaporator configured to evaporate the refrigerant flowing out of the second expansion valve and to cause the refrigerant to flow to the compressor.

The heat medium circuit includes a heat exchange portion and in which a heat medium circulates while flowing through the heat exchange portion and the second evaporator. The first evaporator exchanges heat between the refrigerant and ventilation air blown to a space to be air conditioned, to evaporate the refrigerant and cool the ventilation air. The second evaporator exchanges heat between the heat medium and the refrigerant, to evaporate the refrigerant and cool the heat medium. Furthermore, the heat exchange portion exchanges heat between the temperature regulation target and the heat medium, to cool the temperature regulation target.

In this manner, the temperature regulation target can be cooled using the refrigeration cycle for cooling the ventilation air. In other words, the refrigeration cycle for cooling the ventilation air can also have a function of cooling the temperature regulation target.

Since heat is transferred between the heat exchange portion and the second evaporator by the heat medium, it is possible to avoid restriction of the arrangement of the second evaporator due to the second evaporator having the function of cooling the temperature regulation target. For example, it is possible to avoid a situation where the refrigerant pipe of the refrigeration cycle needs to be lengthened due to the second evaporator having the function of cooling the temperature regulation target. Therefore, regardless of the arrangement of the heat exchange portion, for example, the refrigeration cycle can be made compact, so that the temperature regulating device can have a simple configuration.

According to another aspect of the present disclosure, a temperature regulating device for regulating a temperature of a temperature regulation target includes a refrigeration cycle and a heat medium circuit. The refrigeration cycle includes a compressor configured to compress a refrigerant, a refrigerant radiator configured to radiate heat from the refrigerant flowing out of the compressor, an expansion valve configured to decompress the refrigerant flowing out of the refrigerant radiator, and an evaporator configured to evaporate the refrigerant flowing out of the expansion valve and to cause the refrigerant to flow to the compressor.

The heat medium circuit includes a heat exchange portion, a heat medium radiator, and a flow rate adjustment mechanism, and in which a heat medium circulates while flowing through the refrigerant radiator and at least one of the heat exchange portion or the heat medium radiator. The flow rate adjustment mechanism adjusts a flow rate ratio between a flow rate of the heat medium flowing through the heat exchange portion and a flow rate of the heat medium flowing through the heat medium radiator. The evaporator exchanges heat between the refrigerant and ventilation air blown to the space to be air conditioned, to evaporate the refrigerant and cool the ventilation air. The refrigerant radiator exchanges heat between the heat medium and the refrigerant, to heat the heat medium. The heat medium radiator radiates heat from the heat medium. In addition, the heat exchange portion exchanges heat between the temperature regulation target and the heat medium, to heat the temperature regulation target.

In this manner, the temperature regulation target can be warmed using the refrigeration cycle for cooling the ventilation air. In other words, the refrigeration cycle for cooling the ventilation air can also have a function of warming the temperature regulation target.

Since the heat medium circuit in which the heat medium circulates while flowing through the refrigerant radiator is provided, the arrangement of the refrigerant radiator is less likely to be restricted due to the refrigerant radiator having the function of warming the temperature regulation target for the same reason as in the temperature regulating device according to the above one aspect. Therefore, regardless of the arrangement of the heat exchange portion, for example, the refrigeration cycle can be made compact, so that the temperature regulating device can have a simple configuration.

In the following, embodiments of the present disclosure will be described with reference to the drawings. In the following embodiments, the same or equivalent portions are denoted by the same reference numerals in the drawings.

### First Embodiment

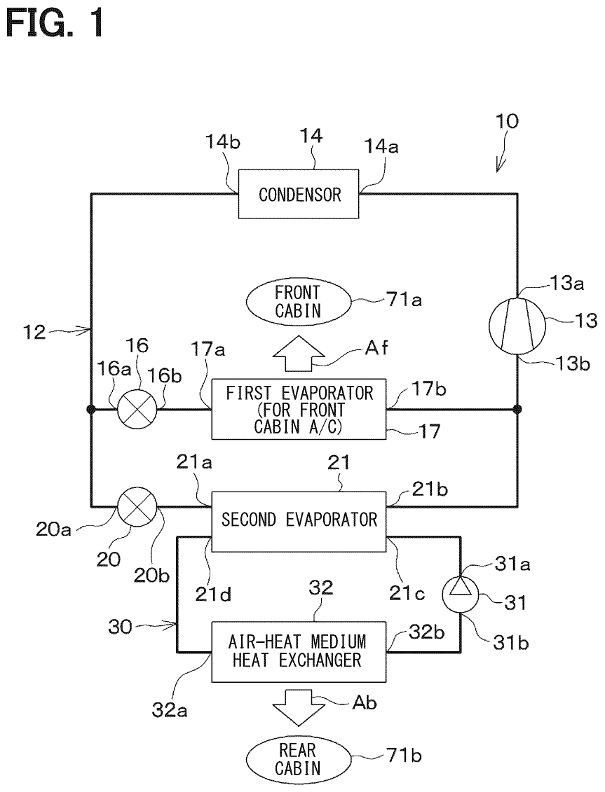

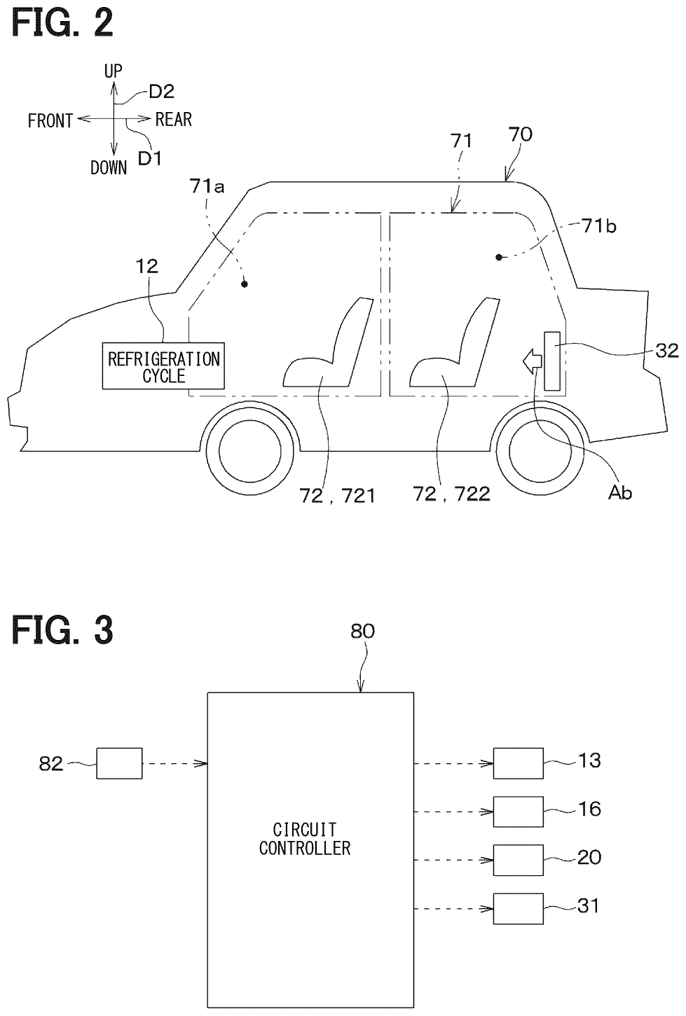

As illustrated in FIGS. 1 and 2, a temperature regulating device 10 of the present embodiment is installed in a vehicle 70. The vehicle 70 is, for example, a hybrid vehicle.

Double-headed arrows in FIG. 2 indicate directions of the vehicle 70 illustrated in FIG. 2. That is, in FIG. 2, a vehicle front-rear direction D1, which is the front-rear direction of the vehicle 70, and a vehicle up-down direction D2, which is the up-down direction of the vehicle 70, are indicated by the double-headed arrows. These directions D1, D2 are directions crossing each other, strictly speaking, directions perpendicular to each other. In the description of the present embodiment, the front in the vehicle front-rear direction D1 is also referred to as the vehicle front, the rear in the vehicle front-rear direction D1 is also referred to as the vehicle rear, the upper in the vehicle up-down direction D2 is also referred to as the vehicle upper, and the lower in the vehicle up-down direction D2 is also referred to as the vehicle lower.

As illustrated in FIG. 2, a vehicle interior space 71, which is separated from the outside of the vehicle 70 and in which occupant seats 72 are disposed, is formed within the vehicle 70. The vehicle interior space 71 includes a front cabin 71a and a rear cabin 71b. The front cabin 71a and the rear cabin 71b occupy parts of the vehicle interior space 71 and are mutually different spaces. The vehicle interior space 71 may also be referred to as the “vehicle interior”.

The front cabin 71a is located in the vehicle front in the vehicle interior space 71, and a front seat 721 of the occupant seats 72 is disposed in the front cabin 71a. The rear cabin 71b is located in the vehicle rear in the vehicle interior space 71, and a rear seat 722 of the occupant seats 72 is disposed in the rear cabin 71b.

As illustrated in FIGS. 1 and 2, the temperature regulating device 10 is a device for regulating the temperature of air Af (i.e., front ventilation air Af) blown to the front cabin 71a of the vehicle 70 and the temperature of air Ab (i.e., rear ventilation air Ab) blown to the rear cabin 71b of the vehicle 70. In the vehicle 70 of the present embodiment, air conditioning is performed separately in the front cabin 71a and the rear cabin 71b.

Specifically, the temperature regulating device 10 of the present embodiment has a function of cooling the front ventilation air Af and a function of cooling the rear ventilation air Ab. In the present embodiment, the front cabin 71a corresponds to the space to be air conditioned according to the present disclosure, the rear cabin 71b corresponds to the temperature regulation space of the present disclosure, the front ventilation air Af corresponds to the ventilation air of the present disclosure, and the rear ventilation air Ab corresponds to the temperature regulation target of the present disclosure.

As illustrated in FIGS. 1 to 3, the temperature regulating device 10 includes a refrigeration cycle 12, a heat medium circuit 30, and a circuit controller 80 that controls the refrigeration cycle 12 and the heat medium circuit 30.

The refrigeration cycle 12 is a vapor compression refrigeration cycle. The refrigeration cycle 12 is operated as a subcritical refrigeration cycle, where the refrigerant pressure on the high-pressure side in the cycle does not exceed the critical pressure of the refrigerant.

The refrigeration cycle 12 is a refrigerant circuit in which a refrigerant circulates, and a refrigerant is sealed in the refrigerant circuit as the refrigeration cycle 12. As the refrigerant circulating in the refrigeration cycle 12, various refrigerants can be adopted, but in the present embodiment, for example, a fluorocarbon refrigerant such as an HFO134a is adopted.

The refrigeration cycle 12 includes a compressor 13, a refrigerant radiator 14, a first expansion valve 16, a first evaporator 17, a second expansion valve 20, a second evaporator 21, and pipes connecting these components.

In the refrigeration cycle 12, a discharge port 13a of the compressor 13 is connected to a refrigerant inlet 14a of the refrigerant radiator 14, and a refrigerant outlet 14b of the refrigerant radiator 14 is connected to a refrigerant inlet 16a of the first expansion valve 16 and a refrigerant inlet 20a of the second expansion valve 20. A refrigerant outlet 16b of the first expansion valve 16 is connected to a refrigerant inlet 17a of the first evaporator 17, and a refrigerant outlet 20b of the second expansion valve 20 is connected to a refrigerant inlet 21a of the second evaporator 21. A refrigerant outlet 17b of the first evaporator 17 and a refrigerant outlet 21b of the second evaporator 21 are both connected to the suction port 13b of the compressor 13.

The compressor 13 includes a discharge port 13a and a suction port 13b, compresses the refrigerant sucked from the suction port 13b, and discharges the compressed refrigerant from the discharge port 13a. The compressor 13 is specifically an electric compressor, and includes a compression mechanism portion that compresses the refrigerant introduced into the compression compartment, and an electric motor that rotationally drives the compression mechanism portion.

The compressor 13 is controlled with a control signal output from the circuit controller 80. For example, the on/off state of the compressor 13 and the number of revolutions (specifically, the number of revolutions of the electric motor of the compressor 13) of the compressor 13 are controlled according to control signals output from the circuit controller 80.

The refrigerant radiator 14 includes the refrigerant inlet 14a into which the refrigerant flows and the refrigerant outlet 14b from which the refrigerant flows out. The high-temperature, high-pressure refrigerant discharged from the compressor 13 flows into the refrigerant inlet 14a of the refrigerant radiator 14.

The refrigerant radiator 14 is a heat exchanger that exchanges heat between the refrigerant and the outside air and radiates heat from the refrigerant to the outside air by the heat exchange. Specifically, the refrigerant radiator 14 is a condenser, and radiates heat from the refrigerant to the outside air and condenses the refrigerant by the heat exchange between the refrigerant and the outside air. The refrigerant radiated heat and condensed in the refrigerant radiator 14 flows out of the refrigerant outlet 14b and flows to the first expansion valve 16 and the second expansion valve 20.

The refrigerant radiator 14 is disposed in the front of vehicle 70 to be exposed to outside air as traveling air during the travel of the vehicle, for example. The outside air is supplied to the refrigerant radiator 14 by the travel of the vehicle or by the operation of a blower (not illustrated). The outside air is air outside the vehicle or air in a space opened to the outside of the vehicle.

The first expansion valve 16 includes the refrigerant inlet 16a into which the refrigerant flows and the refrigerant outlet 16b from which the refrigerant flows out. The first expansion valve 16 is a decompression device that decompresses the refrigerant flowing into the refrigerant inlet 16a of the first expansion valve 16. The first expansion valve 16 allows the decompressed refrigerant to flow out of the refrigerant outlet 16b.

The first expansion valve 16 is an electric expansion valve and includes a valve body and an electric actuator. The electric actuator of the first expansion valve 16 includes, for example, a stepping motor and changes the throttle opening degree of the first expansion valve 16 by displacing the valve body. The electric actuator of the first expansion valve 16 is controlled according to the control signal from the circuit controller 80, so that the throttle opening degree of the first expansion valve 16 is increased or decreased according to the control signal from the circuit controller 80.

The first expansion valve 16 is configured such that its throttle opening degree can be set to zero, that is, configured to be fully closable. When the first expansion valve 16 is fully closed, the flow of the refrigerant from the refrigerant radiator 14 to the first evaporator 17 is blocked. When the first expansion valve 16 is open, the refrigerant decompressed by the first expansion valve 16 flows out of the refrigerant outlet 16b of the first expansion valve 16 and flows to the refrigerant inlet 17a of the first evaporator 17. Accordingly, the refrigeration cycle 12 includes the fully closable first expansion valve 16, so that the refrigerant can be prevented from flowing from the refrigerant radiator 14 to the first evaporator 17.

The first evaporator 17 includes the refrigerant inlet 17a into which the refrigerant flows and the refrigerant outlet 17b from which the refrigerant flows out. The first evaporator 17 is a cooling heat exchanger for cooling the front ventilation air Af blown to the front cabin 71a, and is disposed in an air conditioning unit (not illustrated). The air conditioning unit is disposed, for example, inside an instrument panel provided in the vehicle front in the front cabin 71a. The front ventilation air Af is blown by, for example, a blower included in an air conditioning unit (not illustrated).

For example, the first evaporator 17 is configured by alternately arranging a plurality of tubes through which the refrigerant flows and a plurality of corrugated fins. In the first evaporator 17, air that exchanges heat with the refrigerant passes between the tubes.

Specifically, the first evaporator 17 is disposed in an air passage that is formed within the air conditioning unit and through which the front ventilation air Af flows. The first evaporator 17 exchanges heat between the refrigerant flowing into the refrigerant inlet 17a and the front ventilation air Af passing through the first evaporator 17, evaporating the refrigerant and cooling the front ventilation air Af by the heat exchange. The refrigerant evaporated and absorbed by the first evaporator 17 flows out of the refrigerant outlet 17b and flows to the suction port 13b of the compressor 13. That is, the first evaporator 17 evaporates the refrigerant decompressed by the first expansion valve 16 and flowing out of the first expansion valve 16, and then allows the refrigerant to flow to the suction port 13b of the compressor 13.

The second expansion valve 20 includes the refrigerant inlet 20a into which the refrigerant flows and the refrigerant outlet 20b from which the refrigerant flows out. The second expansion valve 20 decompresses the refrigerant flowing into the refrigerant inlet 20a of the second expansion valve 20, and allows the decompressed refrigerant to flow out of the refrigerant outlet 20b. The refrigerant flowing out of the refrigerant outlet 20b of the second expansion valve 20 flows to the refrigerant inlet 21a of the second evaporator 21.

The second expansion valve 20 is disposed at a different location from the first expansion valve 16, but has a similar configuration to the first expansion valve 16. That is, the second expansion valve 20 includes a valve body and an electric actuator, and the throttle opening degree of the second expansion valve 20 is increased or decreased according to a control signal from the circuit controller 80. The second expansion valve 20 is configured to be fully closable.

When the second expansion valve 20 is fully closed, the flow of the refrigerant from the refrigerant radiator 14 to the second evaporator 21 is blocked. When the second expansion valve 20 is open, the refrigerant decompressed by the second expansion valve 20 flows out of the refrigerant outlet 20b of the second expansion valve 20 and flows to the refrigerant inlet 21a of the second evaporator 21. Accordingly, the refrigeration cycle 12 includes the fully closable second expansion valve 20, so that the refrigerant can be prevented from flowing from the refrigerant radiator 14 to the second evaporator 21.

Since the first expansion valve 16 and the second expansion valve 20 are configured to be fully closable as described above, each valve includes a function as a refrigerant flow path switching portion that selectively switches the refrigerant flow path among, for example, a first flowing state, a second flowing state, and a third flowing state. In the first flowing state, the flow of the refrigerant from the refrigerant radiator 14 to the first evaporator 17 via the first expansion valve 16 is blocked, and the flow of the refrigerant from the refrigerant radiator 14 to the second evaporator 21 via the second expansion valve 20 is allowed. In the second flowing state, the flow of the refrigerant from the refrigerant radiator 14 to the first evaporator 17 via the first expansion valve 16 is allowed, and the flow of the refrigerant from the refrigerant radiator 14 to the second evaporator 21 via the second expansion valve 20 is blocked. In the third flowing state, both the flow of the refrigerant from the refrigerant radiator 14 to the first evaporator 17 via the first expansion valve 16 and the flow of the refrigerant from the refrigerant radiator 14 to the second evaporator 21 via the second expansion valve 20 are allowed.

The second evaporator 21 includes the refrigerant inlet 21a into which the refrigerant flows, the refrigerant outlet 21b from which the refrigerant flows out, a heat medium inlet 21c into which the heat medium of the heat medium circuit 30 flows, and a heat medium outlet 21d from which the heat medium flows out. The second evaporator 21 is a heat exchanger (in other words, a chiller) that exchanges heat between the refrigerant and the heat medium of the heat medium circuit 30. By the heat exchange between the refrigerant and the heat medium, the second evaporator 21 absorbs heat to the refrigerant, evaporating the refrigerant and cooling the heat medium.

The refrigerant having absorbed heat in the second evaporator 21 flows out of the refrigerant outlet 21b and flows to the suction port 13b of the compressor 13. At the same time, the heat medium cooled by the second evaporator 21 flows out of the heat medium outlet 21d. That is, the second evaporator 21 evaporates the refrigerant decompressed by the second expansion valve 20 and flowing out of the second expansion valve 20, and then allows the refrigerant to flow to the suction port 13b of the compressor 13, and allows the heat medium cooled with the evaporation of the refrigerant to flow out of the heat medium outlet 21d.

According to the configuration described above, in the refrigeration cycle 12, when the compressor 13 is in operation, and when the first expansion valve 16 is opened and the second expansion valve 20 is fully closed, the refrigerant flows to the first evaporator 17 but does not flow to the second evaporator 21. Conversely, when the first expansion valve 16 is fully closed and the second expansion valve 20 is open, the refrigerant does not flow to the first evaporator 17 but flows to the second evaporator 21. When both the first expansion valve 16 and the second expansion valve 20 are open, the refrigerant flows to both the first evaporator 17 and the second evaporator 21. As described above, in the refrigeration cycle 12, when the compressor 13 is in operation, the refrigerant evaporates in one or both of the first evaporator 17 and the second evaporator 21 and circulates while radiating heat in the refrigerant radiator 14.

The heat medium circuit 30 includes a pump 31, an air heat exchanger 32 as a heat exchange portion, and pipes connecting these components. The heat medium circuit 30 is a fluid circuit in which the heat medium circulates while flowing through the pump 31, the air heat exchanger 32, and the second evaporator 21. The heat medium circulating in the heat medium circuit 30 is, for example, a liquid, and as the heat medium, for example, an antifreeze solution such as a solution containing ethylene glycol can be adopted.

In the heat medium circuit 30, a discharge port 31a of the pump 31 is connected to the heat medium inlet 21c of the second evaporator 21, and the heat medium outlet 21d of the second evaporator 21 is connected to a heat medium inlet 32a of the air heat exchanger 32. A heat medium outlet 32b of the air heat exchanger 32 is connected to a suction port 31b of the pump 31. Therefore, in the heat medium circuit 30, when the pump 31 is operated, the heat medium discharged from the discharge port 31a of the pump 31 flows through the second evaporator 21 and the air heat exchanger 32 in this order, and is then sucked into the suction port 31b of the pump 31.

The pump 31 is an electric pump that pressure-feeds the heat medium. The pump 31 includes a discharge port 31a and the suction port 31b. The pump 31 discharges the heat medium sucked from the suction port 31b from the discharge port 31a, thereby circulating the heat medium in the heat medium circuit 30.

The on/off state of the pump 31 and the number of revolutions of the pump 31 are controlled according to control signals output from the circuit controller 80. For example, the discharge flow rate of the pump 31 increases as the number of revolutions of the pump 31 increases. That is, the pump 31 can increase or decrease the discharge flow rate of the pump 31.

The air heat exchanger 32 includes a heat medium inlet 32a into which the heat medium flows and a heat medium outlet 32b from which the heat medium flows out. The air heat exchanger 32 is a cooling heat exchanger that cools the rear ventilation air Ab blown to the rear cabin 71b. The rear ventilation air Ab is blown by, for example, a blower (not illustrated).

For example, the air heat exchanger 32 is configured by alternately arranging a plurality of tubes through which a heat medium flows and a plurality of corrugated fins. In the air heat exchanger 32, air that exchanges heat with the heat medium passes between the tubes.

Specifically, the air heat exchanger 32 is disposed in an air passage through which the rear ventilation air Ab flows toward the rear cabin 71b. The air heat exchanger 32 exchanges heat between the heat medium flowing into the heat medium inlet 32a and the rear ventilation air Ab passing through the air heat exchanger 32, causing the heat medium to absorb heat and cooling the rear ventilation air Ab by the heat exchange. The heat medium having absorbed heat in the air heat exchanger 32 flows out of the heat medium outlet 32b and flows to the suction port 31b of the pump 31.

The circuit controller 80 illustrated in FIG. 3 is an electronic control device formed of a computer including a semiconductor memory as a non-transitory tangible recording medium and a processor, and peripheral circuits thereof. The circuit controller 80 executes a computer program stored in the semiconductor memory. By executing this computer program, a method corresponding to the computer program is executed. That is, the circuit controller 80 executes various control processes according to the computer program.

A plurality of control target devices controlled by the circuit controller 80 in the temperature regulating device 10 are connected to the output side of the circuit controller 80. Specifically, the compressor 13 of the refrigeration cycle 12, the first expansion valve 16, the second expansion valve 20, the pump 31 of the heat medium circuit 30, and the like are connected to the output side of the circuit controller 80.

In addition to a plurality of sensors included in the refrigeration cycle 12 or the heat medium circuit 30, an operation panel 82 operated by an occupant is connected to the input side of the circuit controller 80. The operation panel 82 is disposed within the vehicle interior space 71 as an operation device used for various input operations by the occupant. For example, the operation panel 82 is disposed near the instrument panel in the vehicle interior space 71 and includes various operation switches operated by the occupant. Operation signals from various operation switches included in the operation panel 82 are input to the circuit controller 80.

The temperature regulating device 10 of the present embodiment is configured as described above. For example, when the rear ventilation air Ab is cooled by the temperature regulating device 10, the compressor 13 of the refrigeration cycle 12 and the pump 31 of the heat medium circuit 30 are operated. Then, the second expansion valve 20 is brought into a state where the refrigerant can flow, and the throttle opening degree of the second expansion valve 20 is adjusted so that the second expansion valve 20 exerts a decompression action.

As a result, in the refrigeration cycle 12, the refrigerant circulating in the refrigeration cycle 12 evaporates in the second evaporator 21 by absorbing heat from the heat medium of the heat medium circuit 30, and condenses in the refrigerant radiator 14 by radiating heat to the outside air. In the heat medium circuit 30, the heat medium circulating in the heat medium circuit 30 absorbs heat from the rear ventilation air Ab in the air heat exchanger 32 and radiates heat to the refrigerant of the refrigeration cycle 12 in the second evaporator 21. In this manner, the rear ventilation air Ab is cooled.

At this time, the front ventilation air Af may or may not be cooled by the temperature regulating device 10. For example, when the front ventilation air Af is not cooled by the temperature regulating device 10, the first expansion valve 16 is fully closed.

On the other hand, when the front ventilation air Af is also cooled by the temperature regulating device 10 together with the rear ventilation air Ab, the first expansion valve 16 is also brought into a state where the refrigerant can flow, and the throttle opening degree of the first expansion valve 16 is adjusted so that the first expansion valve 16 exerts a decompression action. Accordingly, the refrigerant in the refrigeration cycle 12 evaporates in the first evaporator 17 and absorbs heat from the front ventilation air Af. The refrigerant flowing out of the first evaporator 17 and the refrigerant flowing out of the second evaporator 21 are both sucked into the suction port 13b of the compressor 13. In this manner, the front ventilation air Af is also cooled.

When the rear ventilation air Ab is not cooled and the front ventilation air Af is cooled by the temperature regulating device 10, the compressor 13 of the refrigeration cycle 12 is operated and the pump 31 of the heat medium circuit 30 is stopped. Then, the first expansion valve 16 is brought into a state where the refrigerant can flow, and the throttle opening degree of the first expansion valve 16 is adjusted so that the first expansion valve 16 exerts a decompression action. On the other hand, second expansion valve 20 is fully closed.

Accordingly, in the refrigeration cycle 12, the refrigerant circulating in the refrigeration cycle 12 evaporates in the first evaporator 17 by absorbing heat from the front ventilation air Af, and condenses in the refrigerant radiator 14 by radiating heat to the outside air. In this manner, the front ventilation air Af is cooled.

As described above, according to the present embodiment, the refrigeration cycle 12 includes the compressor 13, the refrigerant radiator 14, the first expansion valve 16, the first evaporator 17, the second expansion valve 20, and the second evaporator 21. In the heat medium circuit 30, the heat medium circulates while flowing through the air heat exchanger 32 and the second evaporator 21. The refrigerant radiator 14 radiates heat from the refrigerant to the outside air. The first evaporator 17 exchanges heat between the refrigerant and the front ventilation air Af, thereby evaporating the refrigerant and cooling the front ventilation air Af. The second evaporator 21 exchanges heat between the refrigerant and the heat medium in the heat medium circuit 30, thereby evaporating the refrigerant and cooling the heat medium. The air heat exchanger 32 exchanges heat between the heat medium and the rear ventilation air Ab, thereby cooling the rear ventilation air Ab.

Thus, the rear ventilation air Ab, which is a temperature regulation target, can be cooled using the refrigeration cycle 12 for cooling the front ventilation air Af. In other words, the refrigeration cycle 12 for cooling the front ventilation air Af can also have a function of cooling the rear ventilation air Ab.

Since heat is transferred by the heat medium between the air heat exchanger 32 in contact with the rear ventilation air Ab and the second evaporator 21, it is possible to avoid restricting the arrangement of the second evaporator 21 due to the second evaporator 21 having the function of cooling the rear ventilation air Ab. For example, it is possible to avoid a situation where the refrigerant pipe of the refrigeration cycle 12 needs to be lengthened due to the second evaporator 21 having a function of cooling the rear ventilation air Ab. Therefore, regardless of the arrangement of the air heat exchanger 32, for example, the refrigeration cycle 12 can be made compact, so that the temperature regulating device 10 can have a simple configuration.

For example, when the refrigeration cycle 12 is made compact and the refrigerant pipe of the refrigeration cycle 12 is shortened as a whole, the complexity of the control of the refrigeration cycle 12 due to the long refrigerant pipe can be avoided.
(1) According to the present embodiment, the heat medium circuit 30 includes the pump 31 that can increase or decrease the flow rate of the heat medium by circulating the heat medium in the heat medium circuit 30. It is thus possible to freely adjust the flow rate of the heat medium flowing through the second evaporator 21 according to the amount of heat absorbed by the refrigerant from the heat medium in the second evaporator 21.
(2) According to the present embodiment, the rear cabin 71b, as a temperature regulation space toward which the rear ventilation air Ab cooled by the air heat exchanger 32 is directed, is a space that occupies a part of the vehicle interior space 71. Thus, the air heat exchanger 32 can be provided at a position relatively close to the constituent devices of the refrigeration cycle 12 (e.g., first and second evaporators 17, 21, etc.). This enables, for example, the pipe of the heat medium circuit 30 to be shortened.

### Second Embodiment

Next, a second embodiment will be described. In the present embodiment, differences from the first embodiment described above will be mainly described. The same or equivalent parts as those in the embodiment described above will be omitted or simplified. This also applies to the description of the embodiments described later.

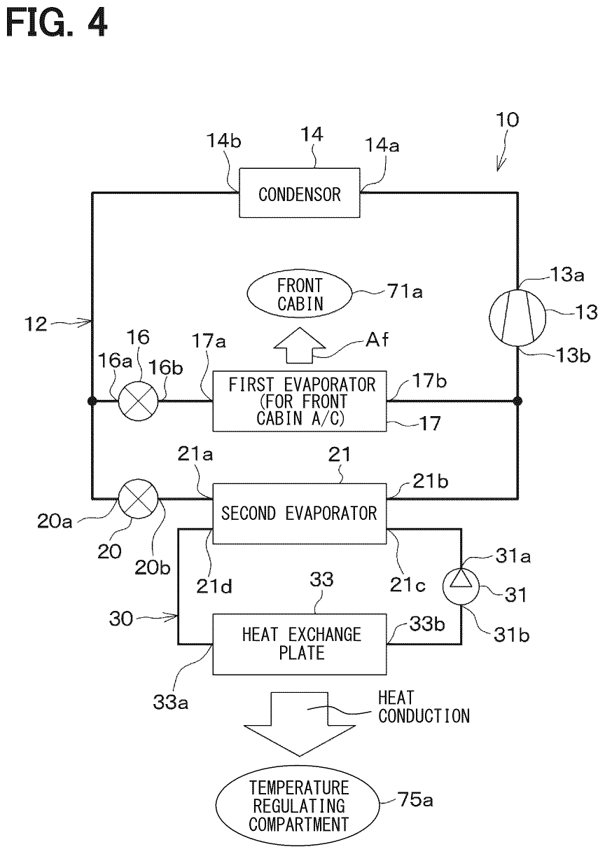

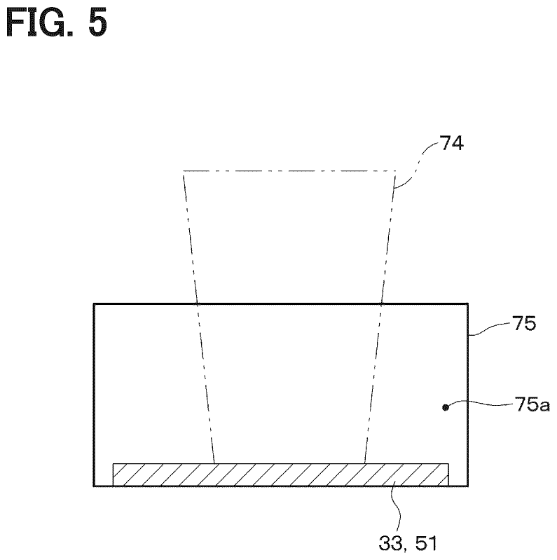

As illustrated in FIGS. 4 and 5, the heat medium circuit 30 of the present embodiment includes a heat exchange plate 33 as a heat exchange portion in place of the air heat exchanger 32 (cf. FIG. 1) of the first embodiment.

The heat exchange plate 33 is made of, for example, a metal plate material having high thermal conductivity, and cools a temperature regulation target 74 by heat conduction between the heat exchange plate 33 and the temperature regulation target 74 in contact with the heat exchange plate 33. The heat exchange plate 33 is provided, for example, in a cup holder inner space 75a as a temperature regulating compartment formed within the cup holder 75 provided in the vehicle interior space 71. The heat exchange plate 33 is disposed at the bottom of the cup holder inner space 75a, and cools a beverage cup or the like that is the temperature regulation target 74 placed on the heat exchange plate 33. In the present embodiment, the temperature regulation target 74 corresponds to the temperature regulation target of the present disclosure.

Specifically, an internal flow passage through which a heat medium flows is formed inside the heat exchange plate 33, and the heat exchange plate 33 includes a heat medium inlet 33a through which the heat medium is allowed to flow into the internal flow passage and a heat medium outlet 33b through which the heat medium is allowed to flow out of the internal flow passage. The heat medium flows through the internal flow passage of the heat exchange plate 33, and the temperature regulation target 74 is in contact with the heat exchange plate 33, whereby heat is exchanged between the heat medium and the temperature regulation target 74.

In the present embodiment, the heat medium inlet 33a of the heat exchange plate 33 is connected to the heat medium outlet 21d of the second evaporator 21, and the heat medium outlet 33b of the heat exchange plate 33 is connected to the suction port 31b of the pump 31. Therefore, in the heat medium circuit 30, when the pump 31 is operated, the heat medium discharged from the discharge port 31a of the pump 31 flows through the second evaporator 21 and the heat exchange plate 33 in this order, and is then sucked into the suction port 31b of the pump 31.

As described above, according to the present embodiment, the heat medium circuit 30 includes the heat exchange plate 33. The heat exchange plate 33 exchanges heat between the temperature regulation target 74, in contact with the heat exchange plate 33, and the heat medium flowing through the heat exchange plate 33 by heat conduction, thereby cooling the temperature regulation target 74. It is thus possible to cool the temperature regulation target 74 by heat conduction without the need to blow air.

The present embodiment is similar to the first embodiment except for the above description. In the present embodiment, effects obtained from the configuration common to the first embodiment described above can be obtained as in the first embodiment.

### Third Embodiment

Next, a third embodiment will be described. In the present embodiment, differences from the first embodiment described above will be mainly described.

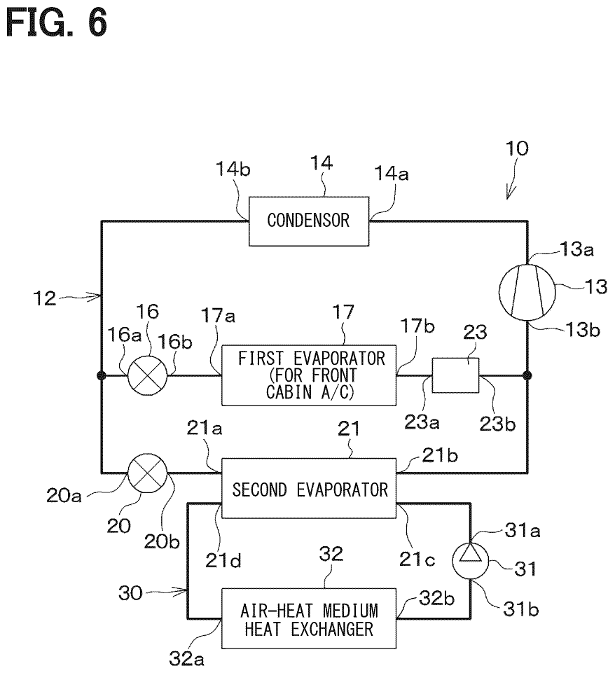

As illustrated in FIG. 6, in the present embodiment, the refrigeration cycle 12 includes a pressure adjustment valve 23. In this respect, the present embodiment differs from the first embodiment.

Specifically, the pressure adjustment valve 23 includes a refrigerant inlet 23a into which the refrigerant flows and a refrigerant outlet 23b from which the refrigerant flows out. The pressure adjustment valve 23 is provided on the refrigerant flow downstream side of the first evaporator 17 and on the refrigerant flow upstream side of the compressor 13. That is, the refrigerant outlet 17b of the first evaporator 17 is connected to the refrigerant inlet 23a of the pressure adjustment valve 23, and the refrigerant outlet 23b of the pressure adjustment valve 23 is connected to the suction port 13b of the compressor 13.

The pressure adjustment valve 23 is a valve device also referred to as an evaporation pressure adjustment valve. To inhibit frost formation in the first evaporator 17, the pressure adjustment valve 23 has a function of adjusting the refrigerant evaporation pressure in the first evaporator 17 to a reference pressure or higher at which frost formation can be inhibited. In other words, the pressure adjustment valve 23 maintains the refrigerant evaporation pressure of the first evaporator 17 to be a predetermined value as the reference pressure or more.

Specifically, the pressure adjustment valve 23 is configured to decrease the throttle opening degree (i.e., the passage area of the refrigerant passage) when the pressure of the refrigerant in the first evaporator 17 becomes lower than the reference pressure, and increase the throttle opening degree when the pressure of the refrigerant exceeds the reference pressure. Accordingly, the pressure adjustment valve 23 maintains the refrigerant evaporation temperature in the first evaporator 17 to be equal to or higher than the frost formation inhibition temperature (e.g., 1° C.) at which frost formation in the first evaporator 17 can be inhibited. For example, the pressure adjustment valve 23 is a mechanical variable throttle mechanism that increases the valve opening degree as the pressure of the refrigerant on the outlet side of the first evaporator 17 increases. The flow rate of the refrigerant flowing through the first evaporator 17 increases or decreases according to the throttle opening degree of the pressure adjustment valve 23. Thus, the pressure adjustment valve 23 also functions as a flow rate adjustment valve.

In the present embodiment, the temperature regulation target cooled by the air heat exchanger 32 is not the rear ventilation air Ab (cf. FIG. 1) but, for example, refrigerating air blown to a refrigeration compartment in which food and drink and the like are stored. The refrigeration compartment corresponds to a temperature regulation space provided within the vehicle 70 while being separated from the outside of the vehicle 70.

(1) As described above, according to the present embodiment, the refrigeration cycle 12 includes the pressure adjustment valve 23. The pressure adjustment valve 23 is provided on the refrigerant flow downstream side of the first evaporator 17 and on the refrigerant flow upstream side of the compressor 13, and maintains the refrigerant evaporation pressure in the first evaporator 17 at a predetermined value or more. Therefore, it is possible to lower the temperature of the refrigeration compartment into which the air cooled by the air heat exchanger 32 flows than the temperature of the vehicle interior space 71 while maintaining the temperature of the vehicle interior space 71 at an appropriate level, for example.

The present embodiment is similar to the first embodiment except for the above description. In the present embodiment, effects obtained from the configuration common to the first embodiment described above can be obtained as in the first embodiment.

Although the present embodiment is a modification based on the first embodiment, the present embodiment can be combined with the second embodiment described above.

### Fourth Embodiment

Next, a fourth embodiment will be described. In the present embodiment, differences from the first embodiment described above will be mainly described.

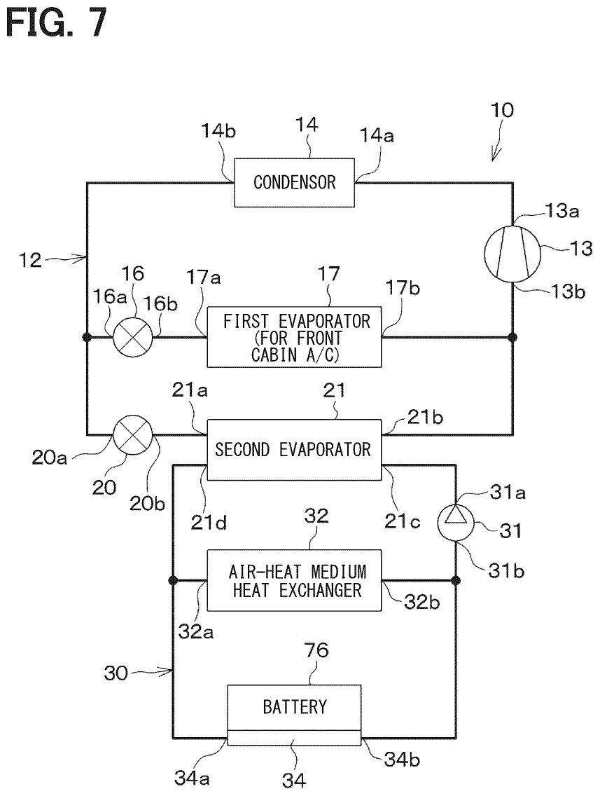

As illustrated in FIG. 7, in the present embodiment, the heat medium circuit 30 includes a battery heat exchanger 34. In this respect, the present embodiment differs from the first embodiment.

Specifically, in the heat medium circuit 30 of the present embodiment, the heat medium outlet 21d of the second evaporator 21 is connected to the heat medium inlet 32a of the air heat exchanger 32 and a heat medium inlet 34a of the battery heat exchanger 34. The suction port 31b of the pump 31 is connected to the heat medium outlet 32b of the air heat exchanger 32 and a heat medium outlet 34b of the battery heat exchanger 34.

The battery heat exchanger 34 is a battery-cooling heat exchanger for cooling a battery 76. The battery 76 functions as a power source of a traveling motor included in the vehicle 70. The battery 76 is a secondary battery that can be repeatedly charged and discharged, and is formed of, for example, a lithium-ion battery or a nickel-metal hydride battery. In order for the battery 76 to exhibit appropriate charge and discharge performance, the temperature of the battery 76 is preferably maintained within a predetermined temperature range, and the battery 76 generates heat in association with the charge and discharge.

The battery heat exchanger 34 includes the heat medium inlet 34a into which the heat medium flows and the heat medium outlet 34b from which the heat medium flows out. The battery heat exchanger 34 exchanges heat between the battery 76 and the heat medium flowing into the battery heat exchanger 34 from the heat medium inlet 34a, thereby cooling the battery 76. The heat medium after the heat exchange with the battery 76 flows out of the heat medium outlet 34b and is sucked into the suction port 31b of the pump 31. For example, the battery heat exchanger 34 is integrated with the battery 76 and configured to cool the battery 76 while equalizing temperatures of a plurality of battery cells included in the battery 76.

In the heat medium circuit 30 configured as described above, when the pump 31 is operated, the heat medium discharged from the discharge port 31a of the pump 31 flows to the second evaporator 21, and flows from the second evaporator 21 to the air heat exchanger 32 and the battery heat exchanger 34 in parallel. Then, the heat medium is sucked into the suction port 31b of the pump 31 from the air heat exchanger 32, and is also sucked into the suction port 31b of the pump 31 from the battery heat exchanger 34.

Therefore, when the pump 31 operates and the heat medium cooled by the second evaporator 21 flows out of the second evaporator 21, the cooled heat medium flows to the air heat exchanger 32 and the battery heat exchanger 34. Hence, when the rear ventilation air Ab (cf. FIG. 2) is cooled by the air heat exchanger 32, the battery 76 is also cooled by the heat medium in the battery heat exchanger 34.

(1) As described above, according to the present embodiment, the heat medium circuit 30 includes the battery heat exchanger 34, and the battery heat exchanger 34 exchanges heat between the battery 76 and the heat medium. Thus, it is also possible to cool the battery 76 using the heat medium circuit 30 that cools the rear ventilation air Ab.

The present embodiment is similar to the first embodiment except for the above description. In the present embodiment, effects obtained from the configuration common to the first embodiment described above can be obtained as in the first embodiment.

Although the present embodiment is a modification based on the first embodiment, the present embodiment can be combined with the second embodiment or the third embodiment described above.

### Fifth Embodiment

Next, a fifth embodiment will be described. In the present embodiment, differences from the first embodiment described above will be mainly described.

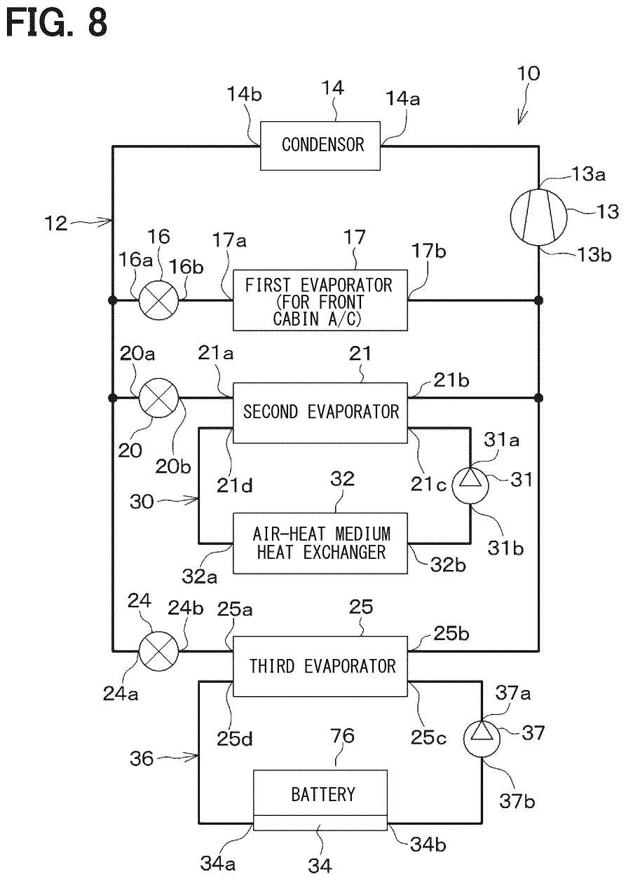

As illustrated in FIG. 8, the temperature regulating device 10 of the present embodiment includes a battery cooling fluid circuit 36. The refrigeration cycle 12 of the present embodiment includes a third expansion valve 24 and a third evaporator 25, and the fluid circuit 36 includes the battery heat exchanger 34. The present embodiment differs from the first embodiment in these points.

Specifically, in the refrigeration cycle 12 of the present embodiment, the refrigerant outlet 14b of the refrigerant radiator 14 is connected to the refrigerant inlet 16a of the first expansion valve 16, the refrigerant inlet 20a of the second expansion valve 20, and a refrigerant inlet 24a of the third expansion valve 24. A refrigerant outlet 24b of the third expansion valve 24 is connected to a refrigerant inlet 25a of the third evaporator 25. The suction port 13b of the compressor 13 is connected to the refrigerant outlet 17b of the first evaporator 17, the refrigerant outlet 21b of the second evaporator 21, and a refrigerant outlet 25b of the third evaporator 25.

The third expansion valve 24 includes the refrigerant inlet 24a into which the refrigerant flows and the refrigerant outlet 24b from which the refrigerant flows out. The third expansion valve 24 decompresses the refrigerant flowing from the refrigerant radiator 14 into the refrigerant inlet 24a of the third expansion valve 24, and allows the decompressed refrigerant to flow out of the refrigerant outlet 24b. The refrigerant flowing out of the refrigerant outlet 24b of the third expansion valve 24 flows to the refrigerant inlet 25a of the third evaporator 25.

The third expansion valve 24 is disposed at a different location from the first expansion valve 16, but has a similar configuration to the first expansion valve 16. That is, the third expansion valve 24 includes a valve body and an electric actuator, and the throttle opening degree of the third expansion valve 24 is increased or decreased according to a control signal from the circuit controller 80 (cf. FIG. 3). The third expansion valve 24 is configured to be fully closable.

When the third expansion valve 24 is fully closed, the flow of the refrigerant from the refrigerant radiator 14 to the third evaporator 25 is blocked. When the third expansion valve 24 is open, the refrigerant decompressed by the third expansion valve 24 flows out of the refrigerant outlet 24b of the third expansion valve 24 and flows to the refrigerant inlet 25a of the third evaporator 25.

Since the third expansion valve 24 is also configured to be fully closable as described above, in the present embodiment, the first expansion valve 16, the second expansion valve 20, and the third expansion valve 24 function as a refrigerant flow path switching portion that switches the refrigerant flow path of the refrigeration cycle 12.

The third evaporator 25 includes the refrigerant inlet 25a into which the refrigerant flows, the refrigerant outlet 25b from which the refrigerant flows out, a fluid inlet 25c into which the battery cooling fluid of the fluid circuit 36 flows, and a fluid outlet 25d from which the battery cooling fluid flows out. The third evaporator 25 is disposed at a different location from the second evaporator 21, but has a similar configuration to the second evaporator 21.

That is, the third evaporator 25 is a heat exchanger (in other words, a chiller) that exchanges heat between the refrigerant and the battery cooling fluid. The third evaporator 25 absorbs heat from the battery cooling fluid to the refrigerant by the heat exchange between the refrigerant and the battery cooling fluid, thereby evaporating the refrigerant and cooling the battery cooling fluid.

The refrigerant having absorbed heat in the third evaporator 25 flows out of the refrigerant outlet 25b and flows to the suction port 13b of the compressor 13. At the same time, the battery cooling fluid cooled by the third evaporator 25 flows out of the fluid outlet 25d. That is, the third evaporator 25 evaporates the refrigerant decompressed by the third expansion valve 24 and flowing out of the third expansion valve 24, then allows the refrigerant to flow to the suction port 13b of the compressor 13, and allows the battery cooling fluid, cooled along with the evaporation of the refrigerant, to flow out of the fluid outlet 25d.

According to the configuration described above, in the refrigeration cycle 12, when the compressor 13 is in operation and the third expansion valve 24 is open, the refrigerant is decompressed by the third expansion valve 24 and then flows to the third evaporator 25. On the other hand, when the third expansion valve 24 is fully closed, the refrigerant does not flow to the third evaporator 25. As described above, in the refrigeration cycle 12, when the compressor 13 is in operation, the refrigerant evaporates in any or all of the first to third evaporators 17, 21, 25 and circulates while radiating heat in the refrigerant radiator 14.

The battery cooling fluid circuit 36 includes a battery cooling pump 37, the battery heat exchanger 34, and pipes connecting these components. In the fluid circuit 36, the battery cooling fluid circulates while flowing through the battery cooling pump 37, the battery heat exchanger 34, and the third evaporator 25. The battery cooling fluid may be the same fluid as the heat medium of the heat medium circuit 30 or various fluids different from the heat medium, but in the present embodiment, the same fluid as the heat medium of the heat medium circuit 30 (specifically, the same liquid as that heat medium) is adopted as the battery cooling fluid.

In the present embodiment, since the battery heat exchanger 34 is included in the fluid circuit 36 and the battery cooling fluid circulates in the fluid circuit 36, the heat medium inlet 34a of the battery heat exchanger 34 is referred to as a fluid inlet 34a, and the heat medium outlet 34b of the battery heat exchanger 34 is referred to as a fluid outlet 34b.

In the fluid circuit 36, a discharge port 37a of the battery cooling pump 37 is connected to the fluid inlet 25c of the third evaporator 25, and the fluid outlet 25d of the third evaporator 25 is connected to the fluid inlet 34a of the battery heat exchanger 34. The fluid outlet 34b of battery heat exchanger 34 is connected to a suction port 37b of the battery cooling pump 37. Therefore, in the fluid circuit 36, when the battery cooling pump 37 operates, the battery cooling fluid discharged from the discharge port 37a of the battery cooling pump 37 flows through the third evaporator 25 and the battery heat exchanger 34 in this order, and is then sucked into the suction port 37b of the battery cooling pump 37.

The battery cooling pump 37 is an electric pump that pressure-feeds a battery cooling fluid. The battery cooling pump 37 includes the discharge port 37a and the suction port 37b, and discharges the battery cooling fluid sucked from the suction port 37b from the discharge port 37a. The on/off state of the battery cooling pump 37 and the number of revolutions of the battery cooling pump 37 are controlled according to control signals output from the circuit controller 80. For example, the discharge flow rate of the battery cooling pump 37 increases as the number of revolutions of the battery cooling pump 37 increases.

The battery heat exchanger 34 of the present embodiment is similar to the battery heat exchanger 34 of the fourth embodiment, except for being provided in the fluid circuit 36. Therefore, the battery heat exchanger 34 of the present embodiment exchanges heat between the battery cooling fluid flowing into the battery heat exchanger 34 from the fluid inlet 34a and the battery 76, thereby cooling the battery 76.

In the present embodiment, for example, the operation of the temperature regulating device 10 when the rear ventilation air Ab is cooled and the operation of the temperature regulating device 10 when the front ventilation air Af is cooled are similar to those in the first embodiment.

When the battery 76 is cooled by the temperature regulating device 10 of the present embodiment, the compressor 13 of the refrigeration cycle 12 and the battery cooling pump 37 of the fluid circuit 36 are operated. Then, the third expansion valve 24 is brought into a state where the refrigerant can flow, and the throttle opening degree of the third expansion valve 24 is adjusted so that the third expansion valve 24 exerts a decompression action.

As a result, in the refrigeration cycle 12, the refrigerant circulating in the refrigeration cycle 12 evaporates in the third evaporator 25 by absorbing heat from the battery cooling fluid in the fluid circuit 36, and condenses in the refrigerant radiator 14 by radiating heat to the outside air. In the fluid circuit 36, the battery cooling fluid absorbs heat from the battery 76 in the battery heat exchanger 34, and radiates heat to the refrigerant of the refrigeration cycle 12 in the third evaporator 25. In this manner, the battery 76 is cooled.

At this time, the first expansion valve 16 and the second expansion valve 20 of the refrigeration cycle 12 may be fully closed or brought into a state where the refrigerant can flow, as necessary.

On the other hand, when the battery 76 is not cooled while the compressor 13 of the refrigeration cycle 12 is in operation, the third expansion valve 24 is fully closed, and the battery cooling pump 37 is stopped.

(1) As described above, according to the present embodiment, in the fluid circuit 36, the battery cooling fluid circulates while flowing through the battery cooling pump 37, the battery heat exchanger 34, and the third evaporator 25 of the refrigeration cycle 12. The third evaporator 25 exchanges heat between the battery cooling fluid and the refrigerant, thereby evaporating the refrigerant and cooling the battery cooling fluid. The battery heat exchanger 34 of the fluid circuit 36 exchanges heat between the battery 76 and the battery cooling fluid. Therefore, the temperature of the heat medium cooled by the second evaporator 21 of the refrigeration cycle 12 can be made different from the temperature of the battery cooling fluid cooled by the third evaporator 25.

The present embodiment is similar to the first embodiment except for the above description. In the present embodiment, effects obtained from the configuration common to the first embodiment described above can be obtained as in the first embodiment.

Although the present embodiment is a modification based on the first embodiment, the present embodiment can be combined with the second embodiment or the third embodiment described above.

### Sixth Embodiment

Next, a sixth embodiment will be described. In the present embodiment, differences from the first embodiment described above will be mainly described.

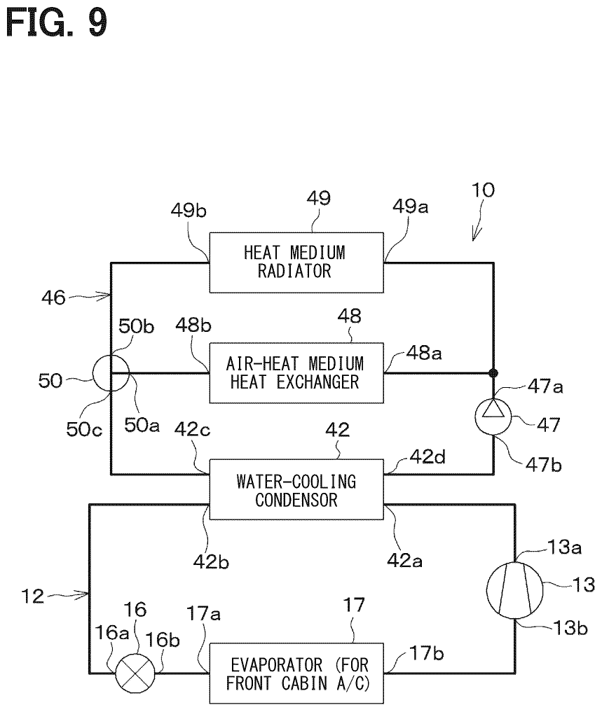

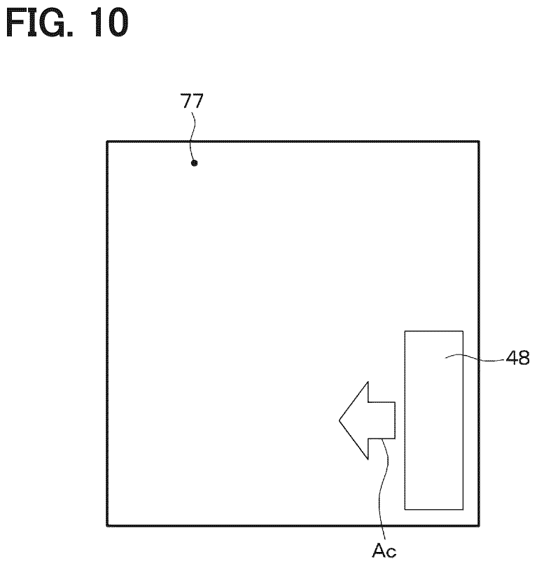

As illustrated in FIGS. 9 and 10, the temperature regulating device 10 of the present embodiment has a function of cooling the front ventilation air Af, but does not have a function of cooling the rear ventilation air Ab. Instead, the temperature regulating device 10 of the present embodiment has a function of warming temperature regulation target air Ac that is air blown to a temperature regulation space 77. In the present embodiment, the temperature regulation target air Ac corresponds to the temperature regulation target of the present disclosure.

The temperature regulation space 77 of the present embodiment is, for example, an internal space of a storage compartment in which small items, food, and the like are stored while the temperature in the space is maintained, and is provided within the vehicle 70 (cf. FIG. 2) while being separated from the outside of the vehicle 70. More specifically, the temperature regulation space 77, which is a space in the storage compartment, is provided to occupy a part of the vehicle interior space 71, for example, or is provided adjacent to the vehicle interior space 71 at a predetermined location around the vehicle interior space 71.

The temperature regulating device 10 of the present embodiment includes the refrigeration cycle 12, a heat medium circuit 46 in place of the heat medium circuit 30 of the first embodiment, and the circuit controller 80 that controls the refrigeration cycle 12 and the heat medium circuit 46. The circuit controller 80 of the present embodiment is similar to the circuit controller 80 of the first embodiment except that the objects to be controlled are the refrigeration cycle 12 and the heat medium circuit 46.

The refrigeration cycle 12 of the present embodiment includes the compressor 13, a refrigerant radiator 42 in place of the refrigerant radiator 14 of the first embodiment, the expansion valve 16, the evaporator 17, and pipes connecting these components. The refrigeration cycle 12 of the present embodiment does not include the second expansion valve 20 (cf. FIG. 1) and the second evaporator 21 of the first embodiment.

In the present embodiment, since the second expansion valve 20 is not provided, the first expansion valve 16 is simply referred to as an expansion valve 16. In the present embodiment, since the second evaporator 21 is not provided, the first evaporator 17 is simply referred to as an evaporator 17.

In the refrigeration cycle 12, the discharge port 13a of the compressor 13 is connected to a refrigerant inlet 42a of the refrigerant radiator 42, and a refrigerant outlet 42b of the refrigerant radiator 42 is connected to the refrigerant inlet 16a of the expansion valve 16. The refrigerant outlet 16b of the expansion valve 16 is connected to the refrigerant inlet 17a of the evaporator 17, and the refrigerant outlet 17b of the evaporator 17 is connected to the suction port 13b of the compressor 13. Therefore, the refrigerant discharged from the discharge port 13a of the compressor 13 flows through the refrigerant radiator 42, the expansion valve 16, and the evaporator 17 in this order, and is sucked into the suction port 13b of the compressor 13.

The compressor 13 of the present embodiment is similar to the compressor 13 of the first embodiment.

The refrigerant radiator 42 includes the refrigerant inlet 42a into which the refrigerant flows, the refrigerant outlet 42b from which the refrigerant flows out, a heat medium inlet 42c into which the heat medium of the heat medium circuit 46 flows, and a heat medium outlet 42d from which the heat medium flows out. The high-temperature, high-pressure refrigerant discharged from the compressor 13 flows into the refrigerant inlet 42a of the refrigerant radiator 42.

The refrigerant radiator 42 is a heat exchanger that exchanges heat between the refrigerant and the heat medium of the heat medium circuit 46, radiating heat from the refrigerant to the heat medium and heating the heat medium by the heat exchange. Specifically, the refrigerant radiator 42 is a condenser, and radiates heat from the refrigerant to the heat medium and condenses the refrigerant by the heat exchange between the refrigerant and the heat medium. The refrigerant radiated heat and condensed in the refrigerant radiator 42 flows out of the refrigerant outlet 42b and flows to the expansion valve 16.

The expansion valve 16 of the present embodiment may be configured to be fully closable similarly to the first expansion valve 16 of the first embodiment, but in the present embodiment, the expansion valve 16 is not configured to be fully closable. Except for this, the expansion valve 16 of the present embodiment is similar to the first expansion valve 16 of the first embodiment.

The evaporator 17 of the present embodiment is similar to the first evaporator 17 of the first embodiment.

According to the above configuration, in the refrigeration cycle 12 of the present embodiment, when the compressor 13 is in operation, the refrigerant discharged from the compressor 13 circulates so as to flow through the refrigerant radiator 42, the expansion valve 16, and the evaporator 17 in this order, and circulates, and return to the compressor 13. The refrigerant radiates heat in the refrigerant radiator 42 and circulates while evaporating in the evaporator 17.

The refrigeration cycle 12 of the present embodiment is similar to the refrigeration cycle 12 of the first embodiment except for the above description.

The heat medium circuit 46 is a fluid circuit in which the heat medium circulates while flowing through the refrigerant radiator 42. The heat medium of the heat medium circuit 46 of the present embodiment may be various fluids different from the heat medium of the heat medium circuit 30 of the first embodiment, but the same fluid as the heat medium of the first embodiment is adopted as the heat medium of the present embodiment. Thus, the heat medium of the heat medium circuit 46 of the present embodiment is also liquid.

The heat medium circuit 46 includes a pump 47, an air heat exchanger 48 as a heat exchange portion, a heat medium radiator 49, a flow rate adjustment mechanism 50, pipes connecting them, and the like. In the heat medium circuit 46, the discharge port 31a of the pump 31 is connected to a heat medium inlet 48a of the air heat exchanger 48 and a heat medium inlet 49a of the heat medium radiator 49. A heat medium outlet 48b of the air heat exchanger 48 is connected to a first inlet port 50a of the flow rate adjustment mechanism 50, and a heat medium outlet 49b of the heat medium radiator 49 is connected to a second inlet port 50b of the flow rate adjustment mechanism 50. An outlet port 50c of the flow rate adjustment mechanism 50 is connected to the heat medium inlet 42c of the refrigerant radiator 42, and the heat medium outlet 42d of the refrigerant radiator 42 is connected to a suction port 47b of the pump 47.

Therefore, in the heat medium circuit 46, when the pump 47 operates, the heat medium discharged from a discharge port 47a of the pump 47 flows to the air heat exchanger 48 or the heat medium radiator 49, depending on the switching state of the flow rate adjustment mechanism 50. Then, the heat medium flows from the air heat exchanger 48 or the heat medium radiator 49 to the flow rate adjustment mechanism 50 and the refrigerant radiator 42 in this order, and is sucked into the suction port 47b of the pump 47 from the refrigerant radiator 42.

The pump 47 of the present embodiment is similar to the pump 31 of the first embodiment. Thus, the pump 47 of the present embodiment includes the discharge port 47a and the suction port 47b. Then, the pump 47 discharges the heat medium sucked from the suction port 47b from the discharge port 47a, thereby circulating the heat medium in the heat medium circuit 46. For example, the discharge flow rate of the pump 47 increases as the number of revolutions of the pump 47 increases. That is, the pump 47 can increase or decrease the discharge flow rate of the pump 47.

The air heat exchanger 48 of the present embodiment is, for example, a heat exchanger including a plurality of tubes and a plurality of corrugated fins similarly to the air heat exchanger 32 of the first embodiment. The air heat exchanger 48 includes the heat medium inlet 48a into which the heat medium flows and the heat medium outlet 48b from which the heat medium flows out. The air heat exchanger 48 is a warming heat exchanger that warms the temperature regulation target air Ac blown to the temperature regulation space 77. The temperature regulation target air Ac is blown by, for example, a blower (not illustrated).

Specifically, the air heat exchanger 48 is disposed in an air passage through which the temperature regulation target air Ac flows toward the temperature regulation space 77. The air heat exchanger 48 exchanges heat between the heat medium flowing into the heat medium inlet 48a and the temperature regulation target air Ac passing through the air heat exchanger 48, radiating heat from the heat medium to the temperature regulation target air Ac and heating the temperature regulation target air Ac by the heat exchange. The heat medium having radiated heat in the air heat exchanger 48 flows out of the heat medium outlet 48b and flows to the first inlet port 50a of the flow rate adjustment mechanism 50.

The heat medium radiator 49 of the present embodiment is, for example, a heat exchanger including a plurality of tubes and a plurality of corrugated fins similarly to the air heat exchanger 48. The heat medium radiator 49 radiates heat from the heat medium in the heat medium radiator 49 to the outside (e.g., the outside of the vehicle 70).

Specifically, the heat medium radiator 49 is a heat exchanger that exchanges heat between the heat medium and the outside air, and includes the heat medium inlet 49a into which the heat medium flows and a heat medium outlet 49b from which the heat medium flows out. The heat medium radiator 49 exchanges heat between the heat medium flowing from the pump 47 into the heat medium inlet 49a and the outside air passing through the heat medium radiator 49, and discharges the heat of the heat medium to the outside of the vehicle 70 by the heat exchange. The heat medium radiator 49 causes the heat medium after the heat exchange to flow from the heat medium outlet 49b to the second inlet port 50b of the flow rate adjustment mechanism 50.

The heat medium radiator 49 is disposed, for example, in the vehicle front in the vehicle 70 so that outside air as traveling air hits the heat medium radiator during the travel of the vehicle. With this arrangement, outside air as traveling air is supplied to the heat medium radiator 49. In addition, the vehicle 70 can supply outside air to the heat medium radiator 49 using a blower (not illustrated) even when the vehicle 70 is stopped.

The flow rate adjustment mechanism 50 of the present embodiment is an electric three-way valve controlled by the circuit controller 80 (cf. FIG. 3). The flow rate adjustment mechanism 50 includes a first inlet port 50a and a second inlet port 50b into which the heat medium flows, and an outlet port 50c from which the heat medium flows out. For example, the flow rate adjustment mechanism 50 includes a valve body that increases or decreases the opening degree of the first inlet port 50a and the opening degree of the second inlet port 50b, and an electric actuator that drives the valve body according to control from the circuit controller 80.

The flow rate adjustment mechanism 50 adjusts a flow rate ratio between the flow rate of the heat medium flowing through the air heat exchanger 48 and the flow rate of the heat medium flowing through the heat medium radiator 49. Specifically, the flow rate adjustment mechanism 50 has a structure in which each of the first inlet port 50a and the second inlet port 50b disconnectably communicate with the outlet port 50c, and increases or decreases the opening degree of the first inlet port 50a and the opening degree of the second inlet port 50b with respect to the outlet port 50c. In the flow rate adjustment mechanism 50, as the opening degree of the first inlet port 50a increases, the opening degree of the second inlet port 50b decreases.

The flow rate adjustment mechanism 50 is configured to such that the first inlet port 50a and the second inlet port 50b are fully closable. For example, when the first inlet port 50a is fully closed, the opening degree of the second inlet port 50b is maximized in a state where the second inlet port 50b and the outlet port 50c communicate with each other. Conversely, when the second inlet port 50b is fully closed, the opening degree of the first inlet port 50a is maximized in a state where the first inlet port 50a and the outlet port 50c communicate with each other. The full closing of each of the first and second inlet ports 50a, 50b means that the inlet port is closed and the flow of the heat medium at the inlet port is blocked, in short, the opening degree of the inlet port is zero.

With such a configuration, when the pump 47 of the heat medium circuit 46 is in operation, the flow rate of the heat medium flowing through the air heat exchanger 48 connected to the first inlet port 50a increases as the opening degree of the first inlet port 50a increases. As the opening degree of the second inlet port 50b increases, the flow rate of the heat medium flowing through the heat medium radiator 49 connected to the second inlet port 50b increases. The heat medium circulating in the heat medium circuit 46 may flow to one of the air heat exchanger 48 or the heat medium radiator 49 or may flow to both the air heat exchanger 48 and the heat medium radiator 49, depending on the state of the flow rate adjustment mechanism 50.

The heat medium circuit 46 of the present embodiment is similar to the heat medium circuit 30 of the first embodiment except for the above description.

The temperature regulating device 10 of the present embodiment is configured as described above. For example, when the temperature regulation target air Ac is warmed by the temperature regulating device 10, the compressor 13 of the refrigeration cycle 12 and the pump 47 of the heat medium circuit 46 are operated. Then, the flow rate adjustment mechanism 50 opens the first inlet port 50a and causes the first inlet port 50a and the outlet port 50c to communicate with each other.

Accordingly, in the refrigeration cycle 12, the refrigerant circulates so as to flow from the compressor 13 to the refrigerant radiator 42, the expansion valve 16, and the evaporator 17 in this order, and return to the compressor 13. The refrigerant circulating in the refrigeration cycle 12 evaporates in the evaporator 17, absorbing heat from the front ventilation air Af (cf. FIG. 1), and condenses in the refrigerant radiator 42, radiating heat to the heat medium of the heat medium circuit 46. As a result, the heat medium of the heat medium circuit 46 is heated by the refrigerant radiator 42. In this case, the front ventilation air Af is cooled by the evaporator 17. For example, the cooled front ventilation air Af is heated as necessary by a heater core disposed within an air conditioning unit (not illustrated) including the evaporator 17, and then blown to the front cabin 71a.

In the heat medium circuit 46, the heat medium heated by the refrigerant radiator 42 flows from the refrigerant radiator 42 to the air heat exchanger 48 via the pump 47, and radiates heat to the temperature regulation target air Ac in the air heat exchanger 48. As a result, the temperature regulation target air Ac passing through the air heat exchanger 48 is heated. The heat medium having radiated heat in the air heat exchanger 48 flows from the air heat exchanger 48 to the refrigerant radiator 42 via the flow rate adjustment mechanism 50, and is heated again in the refrigerant radiator 42.

At this time, the flow rate adjustment mechanism 50 may cause not only the first inlet port 50a but also the second inlet port 50b to communicate with the outlet port 50c, but in the present embodiment, the second inlet port 50b is fully closed.

When the temperature regulation target air Ac is not warmed by the temperature regulating device 10 and the front ventilation air Af is cooled, the compressor 13 of the refrigeration cycle 12 and the pump 47 of the heat medium circuit 46 are operated. The flow rate adjustment mechanism 50 causes the second inlet port 50b and the outlet port 50c to communicate with each other while fully closing the first inlet port 50a.

As a result, the refrigerant circulating in the refrigeration cycle 12 condenses in the refrigerant radiator 42, radiating heat to the heat medium of the heat medium circuit 46, and evaporates in the evaporator 17, absorbing heat from the front ventilation air Af. In this manner, the front ventilation air Af is cooled.

In the heat medium circuit 46, the heat medium heated by the refrigerant radiator 42 flows from the refrigerant radiator 42 to the heat medium radiator 49 via the pump 47, and radiates heat to the outside air in the heat medium radiator 49. The heat medium radiated by the heat medium radiator 49 flows from the heat medium radiator 49 to the refrigerant radiator 42 via the flow rate adjustment mechanism 50, and is heated again by the refrigerant radiator 42. At this time, since the first inlet port 50a is fully closed as described above, the heat medium does not flow through the air heat exchanger 48, and heat is not exchanged in the air heat exchanger 48.

As described above, according to the present embodiment, the refrigeration cycle 12 includes the compressor 13, the refrigerant radiator 42, the expansion valve 16, and the evaporator 17. In the heat medium circuit 46, the heat medium circulates while flowing through the refrigerant radiator 42 and at least one of the air heat exchanger 48 or the heat medium radiator 49. The flow rate adjustment mechanism 50 of the heat medium circuit 46 adjusts the flow rate ratio between the flow rate of the heat medium flowing through the air heat exchanger 48 and the flow rate of the heat medium flowing through the heat medium radiator 49. The evaporator 17 exchanges heat between the refrigerant and the front ventilation air Af, thereby evaporating the refrigerant and cooling the front ventilation air Af. The refrigerant radiator 42 exchanges heat between the refrigerant and the heat medium of the heat medium circuit 46, thereby heating the heat medium. The heat medium radiator 49 of the heat medium circuit 46 radiates heat from the heat medium to the outside (e.g., the outside of the vehicle 70), and the air heat exchanger 48 exchanges heat between the heat medium and the temperature regulation target air Ac, thereby heating the temperature regulation target air Ac.

Thus, the temperature regulation target air Ac, that is a temperature regulation target, can be warmed using the refrigeration cycle 12 for cooling the front ventilation air Af. In other words, the refrigeration cycle 12 for cooling the front ventilation air Af can also have a function of warming the temperature regulation target air Ac.

In the temperature regulating device 10 of the present embodiment, heat is transferred by the heat medium between each of the air heat exchanger 48 and the heat medium radiator 49 and the refrigerant radiator 42. Hence, it is possible to avoid restriction of the arrangement of the refrigerant radiator 42 due to the addition of the function of warming the temperature regulation target air Ac to the refrigeration cycle 12. Therefore, regardless of the arrangement of the air heat exchanger 48 and the heat medium radiator 49, for example, the refrigeration cycle 12 can be made compact, so that the temperature regulating device 10 can have a simple configuration.

(1) According to the present embodiment, the heat medium circuit 46 includes the pump 47 that can increase or decrease the flow rate of the heat medium by circulating the heat medium in the heat medium circuit 46. Therefore, it is possible to freely adjust the flow rate of the heat medium flowing through the refrigerant radiator 42 according to the amount of heat radiated from the refrigerant to the heat medium by the refrigerant radiator 42.

The present embodiment is similar to the first embodiment except for the above description. In the present embodiment, effects obtained from the configuration common to the first embodiment described above can be obtained as in the first embodiment.

### Seventh Embodiment

Next, a seventh embodiment will be described. In the present embodiment, differences from the sixth embodiment described above will be mainly described.

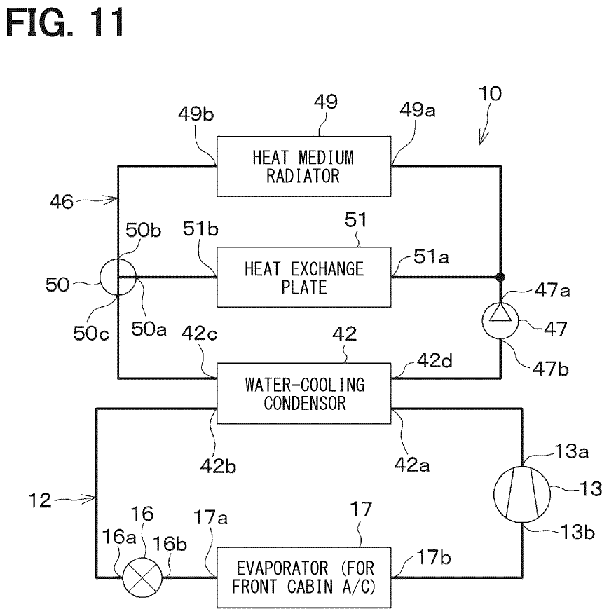

As illustrated in FIG. 11, the heat medium circuit 46 of the present embodiment includes a heat exchange plate 51 as a heat exchange portion in place of the air heat exchanger 48 (cf. FIG. 9) of the sixth embodiment.

The heat exchange plate 51 of the present embodiment heats the temperature regulation target 74 (cf. FIG. 5) using the heat medium flowing inside the heat exchange plate 51. Except for this, the heat exchange plate 51 of the present embodiment is similar to the heat exchange plate 33 of the second embodiment.

Therefore, as illustrated in FIG. 5, for example, the heat exchange plate 51 of the present embodiment is provided in the cup holder inner space 75a, and warms a beverage cup or the like, which is the temperature regulation target 74 placed on the heat exchange plate 51. In the present embodiment, similarly to the second embodiment, the temperature regulation target 74 corresponds to the temperature regulation target of the present disclosure.

The heat exchange plate 51 includes a heat medium inlet 51a through which the heat medium flows into the internal flow passage of the heat exchange plate 51 and a heat medium outlet 51b through which the heat medium flows out of the internal flow passage. The heat medium inlet 51a of the heat exchange plate 51 is connected to the discharge port 47a of the pump 47, and the heat medium outlet 51b of the heat exchange plate 51 is connected to the first inlet port 50a of the flow rate adjustment mechanism 50.

As described above, according to the present embodiment, as illustrated in FIGS. 5 and 11, the heat medium circuit 46 includes the heat exchange plate 51. The heat exchange plate 51 exchanges heat between the temperature regulation target 74 in contact with the heat exchange plate 51 and the heat medium flowing through the heat exchange plate 51 by heat conduction, thereby heating the temperature regulation target 74. It is thus possible to heat the temperature regulation target 74 by heat conduction without requiring air blowing.

The present embodiment is similar to the sixth embodiment except for the above description. In the present embodiment, effects obtained from the configuration common to the sixth embodiment described above can be obtained as in the sixth embodiment.

### Eighth Embodiment

Next, an eighth embodiment will be described. In the present embodiment, differences from the first embodiment described above will be mainly described.

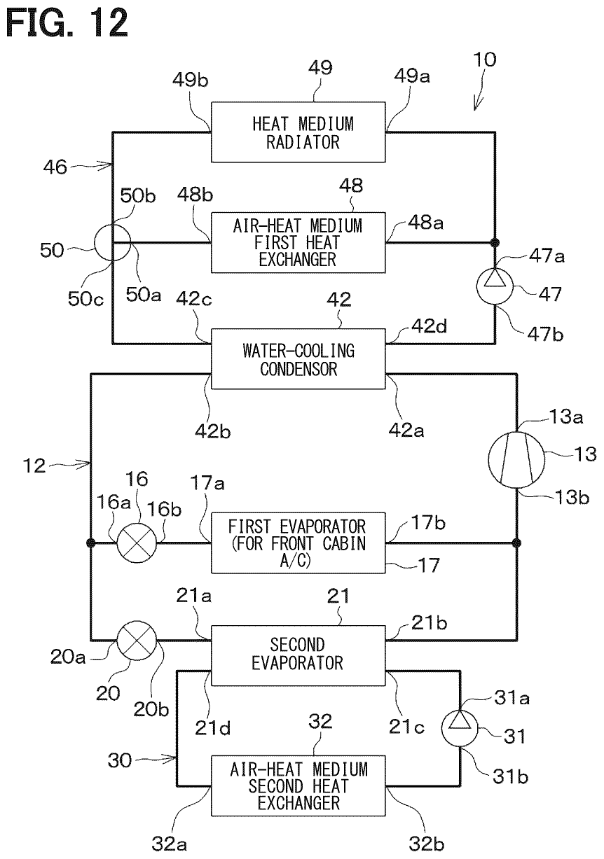

As illustrated in FIG. 12, the temperature regulating device 10 of the present embodiment has a function of cooling the front ventilation air Af, but does not have a function of cooling the rear ventilation air Ab. Instead, the temperature regulating device 10 of the present embodiment has a function of warming the temperature regulation target air Ac blown to the temperature regulation space 77 of FIG. 10 and a function of cooling the temperature regulation target air Ac. In short, the temperature regulating device 10 of the present embodiment has a configuration in which the temperature regulating device 10 of the first embodiment and the temperature regulating device 10 of the sixth embodiment are combined.

As in the first embodiment, the temperature regulating device 10 of the present embodiment includes the refrigeration cycle 12, the heat medium circuit 30, and the circuit controller 80. Furthermore, the temperature regulating device 10 of the present embodiment also includes the heat medium circuit 46 of the sixth embodiment. The circuit controller 80 of the present embodiment is similar to the circuit controller 80 of the first embodiment except that the objects to be controlled are the refrigeration cycle 12 and the two heat medium circuits 30, 46.

In the present embodiment, since the two heat medium circuits 30, 46 are provided, the heat medium circuit 46, similar to that of the sixth embodiment, is referred to as a first heat medium circuit 46, and the heat medium circuit 30, similar to that of the first embodiment, is referred to as a second heat medium circuit 30. The air heat exchanger 48 of the first heat medium circuit 46 is referred to as a first air heat exchanger 48 and is provided as a first heat exchange portion. The pump 47 of the first heat medium circuit 46 is referred to as a first pump 47, and the heat medium of the first heat medium circuit 46 is referred to as a first heat medium. The air heat exchanger 32 of the second heat medium circuit 30 is referred to as a second air heat exchanger 32 and is provided as a second heat exchange portion. The pump 31 of the second heat medium circuit 30 is referred to as a second pump 31, and the heat medium of the second heat medium circuit 30 is referred to as a second heat medium.

The refrigeration cycle 12 of the present embodiment includes the refrigerant radiator 14 of the sixth embodiment in place of the refrigerant radiator 42 of the first embodiment. In the refrigeration cycle 12 of the present embodiment, the refrigerant inlet 42a of the refrigerant radiator 42 is connected to the discharge port 13a of the compressor 13, and the refrigerant outlet 42b of the refrigerant radiator 42 is connected to the refrigerant inlet 16a of the first expansion valve 16 and the refrigerant inlet 20a of the second expansion valve 20.

The first air heat exchanger 48 of the present embodiment exchanges heat between the first heat medium and the temperature regulation target air Ac (cf. FIG. 10) as the first temperature regulation target, and heats the temperature regulation target air Ac by the heat exchange.

The second air heat exchanger 32 of the present embodiment exchanges heat between the second heat medium and the temperature regulation target air Ac (cf. FIG. 10) as the second temperature regulation target, and cools the temperature regulation target air Ac by the heat exchange. Therefore, in the present embodiment, both the first and second temperature regulation targets are the temperature regulation target air Ac, and hence, the same temperature regulation target.

The refrigerant radiator 42 of the present embodiment is similar to the refrigerant radiator 42 of the sixth embodiment except for the above description, and the refrigeration cycle 12 of the present embodiment is similar to the refrigeration cycle 12 of the first embodiment. The first heat medium circuit 46 of the present embodiment is similar to the heat medium circuit 46 of the sixth embodiment except for the above description, and the second heat medium circuit 30 of the present embodiment is similar to the heat medium circuit 30 of the first embodiment.

The temperature regulating device 10 of the present embodiment is as described above. For example, when the temperature regulation target air Ac is warmed by the temperature regulating device 10, the compressor 13 of the refrigeration cycle 12 and the first pump 47 of the first heat medium circuit 46 are operated, and the second pump 31 of the second heat medium circuit 30 is stopped. The flow rate adjustment mechanism 50 opens the first inlet port 50a, causing the first inlet port 50a and the outlet port 50c to communicate with each other.

The first expansion valve 16 is brought into a state where the refrigerant can flow, and the throttle opening degree of the first expansion valve 16 is adjusted so that the first expansion valve 16 exerts a decompression action while the second expansion valve 20 is fully closed. By fully closing the second expansion valve 20, a situation where the temperature regulation target air Ac to be warmed is cooled by the second air heat exchanger 32 is avoided.

Due to the operations described above and the like, in the refrigeration cycle 12, the refrigerant circulates so as to flow from the compressor 13 to the refrigerant radiator 42, the first expansion valve 16, and the first evaporator 17 in this order, and return to the compressor 13, but the refrigerant does not flow to the second evaporator 21. In the first heat medium circuit 46, the first heat medium heated by the refrigerant radiator 42 flows from the refrigerant radiator 42 to the first air heat exchanger 48 via the first pump 47, and radiates heat to the temperature regulation target air Ac in the first air heat exchanger 48. As a result, the temperature regulation target air Ac passing through the first air heat exchanger 48 is heated.

Therefore, in this case, the operation of the refrigeration cycle 12 of the present embodiment is similar to the operation of the refrigeration cycle 12 when the temperature regulation target air Ac is warmed in the sixth embodiment. The operation of the first heat medium circuit 46 of the present embodiment is similar to the operation of the heat medium circuit 46 when the temperature regulation target air Ac is warmed in the sixth embodiment.

At this time, the flow rate adjustment mechanism 50 may cause not only the first inlet port 50a but also the second inlet port 50b to communicate with the outlet port 50c, but in the present embodiment, similarly to the sixth embodiment, the second inlet port 50b is fully closed.

When the temperature regulation target air Ac is cooled by the temperature regulating device 10, the compressor 13 of the refrigeration cycle 12, the first pump 47 of the first heat medium circuit 46, and the second pump 31 of the second heat medium circuit 30 are operated. The second expansion valve 20 is brought into a state where the refrigerant can flow, and the throttle opening degree of the second expansion valve 20 is adjusted so that the second expansion valve 20 exerts a decompression action.

The flow rate adjustment mechanism 50 causes the second inlet port 50b and the outlet port 50c to communicate with each other while fully closing the first inlet port 50a. By fully closing the first inlet port 50a of the flow rate adjustment mechanism 50, a situation where the temperature regulation target air Ac to be cooled is warmed by the first air heat exchanger 48 is avoided.

Due to the operations described above and the like, in the refrigeration cycle 12, the refrigerant circulating in the refrigeration cycle 12 evaporates in the second evaporator 21, absorbing heat from the second heat medium in the second heat medium circuit 30, and condenses in the refrigerant radiator 42, radiating heat to the first heat medium in the first heat medium circuit 46. In the first heat medium circuit 46, the first heat medium heated by the refrigerant radiator 42 flows from the refrigerant radiator 42 to the heat medium radiator 49 via the first pump 47, and radiates heat to the outside air in the heat medium radiator 49. The heat medium radiated by the heat medium radiator 49 flows from the heat medium radiator 49 to the refrigerant radiator 42 via the flow rate adjustment mechanism 50, and is heated again by the refrigerant radiator 42. At this time, since the first inlet port 50a is fully closed as described above, the first heat medium does not flow through the first air heat exchanger 48, and heat exchange in the first air heat exchanger 48 is not performed.

In the second heat medium circuit 30, the second heat medium circulating in the second heat medium circuit 30 absorbs heat from the temperature regulation target air Ac in the second air heat exchanger 32, and radiates heat to the refrigerant of the refrigeration cycle 12 in the second evaporator 21. In this manner, the temperature regulation target air Ac is cooled.

At this time, the front ventilation air Af may or may not be cooled by the temperature regulating device 10. For example, when the front ventilation air Af is not cooled by the temperature regulating device 10, the first expansion valve 16 is fully closed.

On the other hand, when the front ventilation air Af is cooled by the temperature regulating device 10 together with the temperature regulation target air Ac, the first expansion valve 16 is also brought into a state where the refrigerant can flow, and the throttle opening degree of the first expansion valve 16 is adjusted so that the first expansion valve 16 exerts a decompression action. Accordingly, the refrigerant in the refrigeration cycle 12 evaporates in the first evaporator 17 and absorbs heat from the front ventilation air Af. The refrigerant flowing out of the first evaporator 17 and the refrigerant flowing out of the second evaporator 21 are both sucked into the suction port 13b of the compressor 13. In this manner, the front ventilation air Af is also cooled.

When the front ventilation air Af is cooled without the temperature regulation target air Ac being heated or cooled by the temperature regulating device 10, the compressor 13 of the refrigeration cycle 12 and the first pump 47 of the first heat medium circuit 46 are operated, and the second pump 31 of the second heat medium circuit 30 is stopped. The flow rate adjustment mechanism 50 causes the second inlet port 50b and the outlet port 50c to communicate with each other while fully closing the first inlet port 50a. The first expansion valve 16 is brought into a state where the refrigerant can flow, and the throttle opening degree of the first expansion valve 16 is adjusted so that the first expansion valve 16 exerts a decompression action while the second expansion valve 20 is fully closed.

As a result, the refrigerant circulating in the refrigeration cycle 12 condenses in the refrigerant radiator 42, radiating heat to the first heat medium in the first heat medium circuit 46, and evaporates in the first evaporator 17, absorbing heat from the front ventilation air Af. In this manner, the front ventilation air Af is cooled.

In the first heat medium circuit 46, the first heat medium heated by the refrigerant radiator 42 flows from the refrigerant radiator 42 to the heat medium radiator 49 via the first pump 47, and radiates heat to the outside air in the heat medium radiator 49. The first heat medium having radiated heat in the heat medium radiator 49 flows from the heat medium radiator 49 to the refrigerant radiator 42 via the flow rate adjustment mechanism 50, and is heated again in the refrigerant radiator 42. At this time, since the first inlet port 50a is fully closed as described above, the first heat medium does not flow through the first air heat exchanger 48, and heat exchange in the first air heat exchanger 48 is not performed.

(1) As described above, according to the present embodiment, the refrigerant radiator 42 of the refrigeration cycle 12 exchanges heat between the refrigerant and the first heat medium of the first heat medium circuit 46, thereby heating the first heat medium. Then, the first air heat exchanger 48 of the first heat medium circuit 46 exchanges heat between the first heat medium and the temperature regulation target air Ac (cf. FIG. 10), thereby heating the temperature regulation target air Ac. On the other hand, the second evaporator 21 of the refrigeration cycle 12 exchanges heat between the refrigerant and the second heat medium of the second heat medium circuit 30, thereby evaporating the refrigerant and cooling the second heat medium. The air heat exchanger 32 of the second heat medium circuit 30 exchanges heat between the second heat medium and the temperature regulation target air Ac, thereby cooling the temperature regulation target air Ac. Therefore, the temperature regulation target air Ac blown to the temperature regulation space 77 in FIG. 10 can be warmed or cooled using the temperature regulating device 10 of the present embodiment.

According to the present embodiment, when the flow rate adjustment mechanism 50 allows the first heat medium to flow to the first air heat exchanger 48, the refrigerant flows from the refrigerant radiator 42 to the first evaporator 17 in the refrigeration cycle 12 while the refrigerant is prevented from flowing from the refrigerant radiator 42 to the second evaporator 21. As a result, when the temperature regulation target air Ac is warmed, it is possible to avoid a situation where the temperature regulation target air Ac to be warmed is cooled by the second air heat exchanger 32.

According to the present embodiment, when the refrigerant in the refrigeration cycle 12 flows from the refrigerant radiator 42 to the second evaporator 21, the flow rate adjustment mechanism 50 allows the first heat medium to flow to the heat medium radiator 49 while preventing the first heat medium from flowing to the first air heat exchanger 48. Accordingly, when the temperature regulation target air Ac is cooled, it is possible to avoid a situation where the temperature regulation target air Ac to be cooled is warmed by the first air heat exchanger 48.

The present embodiment is similar to the first embodiment except for the above description. In the present embodiment, effects obtained from the configuration common to the first embodiment described above can be obtained as in the first embodiment. In addition, in the present embodiment, a configuration common to the sixth embodiment described above is also provided, so that effects obtained from the configuration common to the sixth embodiment described above can be obtained as in the sixth embodiment.

Although the present embodiment is a modification based on the first embodiment, the present embodiment can be combined with any of the second to fifth embodiments and the seventh embodiment described above.

### Ninth Embodiment

Next, a ninth embodiment will be described. In the present embodiment, differences from the eighth embodiment described above will be mainly described.

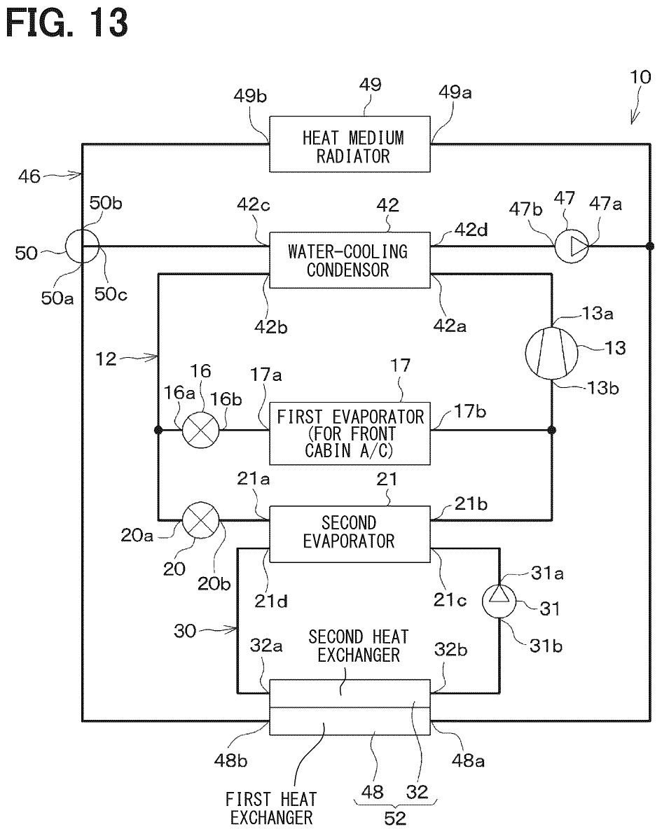

As illustrated in FIG. 13, in the present embodiment, the circuit configurations of the refrigeration cycle 12, the first heat medium circuit 46, and the second heat medium circuit 30 are similar to those of the eighth embodiment.

Specifically, in the present embodiment, the first air heat exchanger 48 and the second air heat exchanger 32 are integrally formed by bolting or the like to constitute a composite heat exchanger 52. In the composite heat exchanger 52, for example, the first air heat exchanger 48 and the second air heat exchanger 32 are stacked, and one of the first air heat exchanger 48 and the second air heat exchanger 32 is disposed on the upstream side of the other in the flow direction of the temperature regulation target air Ac.

(1) As described above, according to the present embodiment, the first air heat exchanger 48 and the second air heat exchanger 32 are formed integrally. Therefore, since the portion for cooling the temperature regulation target air Ac and the portion for warming the temperature regulation target air Ac are integrated in the composite heat exchanger 52, the temperature regulating device 10 can made into a compact and simple system.

The present embodiment is similar to the eighth embodiment except for the above description. In the present embodiment, effects obtained from the configuration common to the eighth embodiment described above can be obtained as in the eighth embodiment.

### Tenth Embodiment

Next, a tenth embodiment will be described. In the present embodiment, differences from the first embodiment described above will be mainly described.

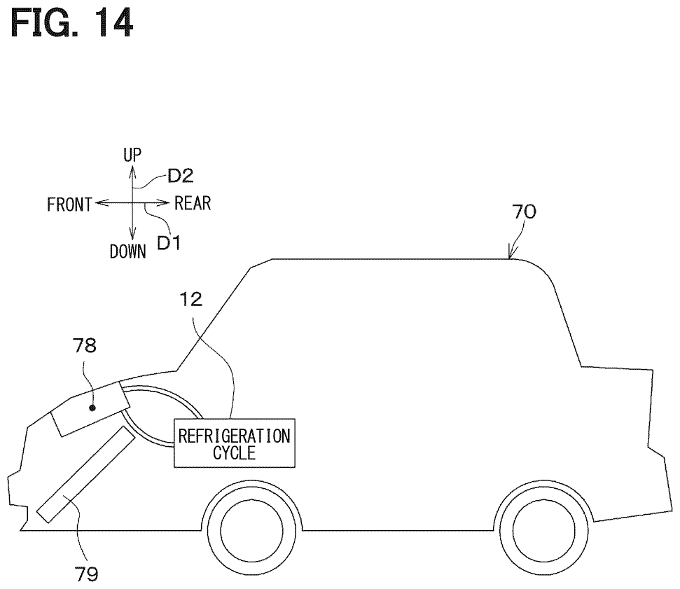

As illustrated in FIGS. 1 and 14, the air heat exchanger 32 of the present embodiment cools not the rear ventilation air Ab but the luggage compartment air as the temperature regulation target that is the air blown to a luggage compartment 78. The luggage compartment 78 is separated from the outside of the vehicle 70 and formed as a temperature regulation space provided within the vehicle 70. For example, the luggage compartment 78 is provided above an engine compartment where a radiator 79 that radiates heat from engine cooling water, an engine, and the like are housed, and is formed to be separated from the engine compartment. Hence, the luggage compartment 78 is located around the vehicle interior space 71.

The present embodiment is similar to the first embodiment except for the above description. In the present embodiment, effects obtained from the configuration common to the first embodiment described above can be obtained as in the first embodiment.

Although the present embodiment is a modification based on the first embodiment, the present embodiment can be combined with any of the third to sixth embodiments, the eighth embodiment, and the ninth embodiment described above.

### Other Embodiments

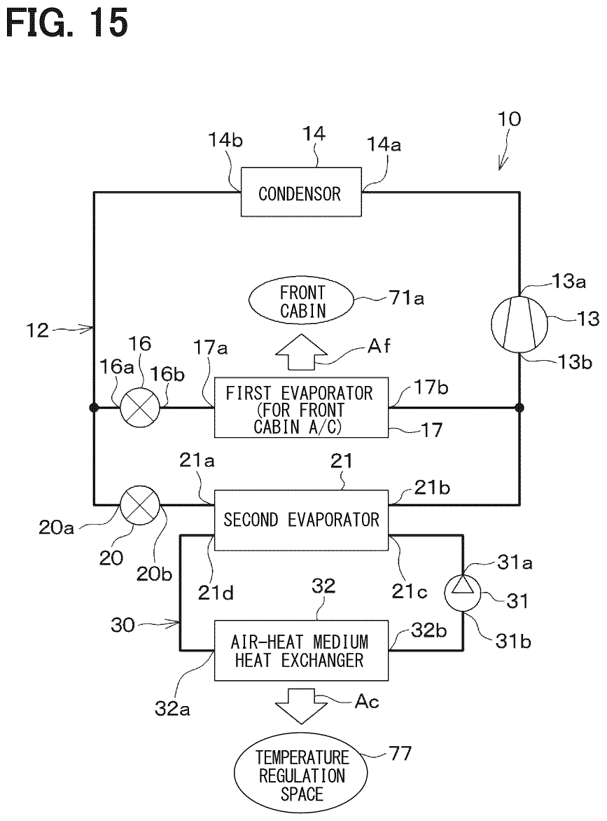

(1) In each of the embodiments described above, as illustrated in FIG. 1, the vehicle 70 in which the temperature regulating device 10 is installed is, for example, a hybrid vehicle. However, the vehicle 70 may be an electric vehicle or an engine vehicle not including a traveling motor. Furthermore, the temperature regulating device 10 may not be installed in the vehicle 70.
(2) In each of the embodiments described above, for example, the refrigeration cycle 12 illustrated in FIG. 1 is operated as a subcritical refrigeration cycle, where the refrigerant pressure on the high-pressure side in the cycle does not exceed the critical pressure of the refrigerant. However, this is an example. For example, the refrigeration cycle 12 may be operated as a supercritical cycle, where the refrigerant pressure on the high-pressure side in the cycle becomes equal to or higher than the critical pressure of the refrigerant.
(3) In the second embodiment described above, as illustrated in FIG. 5, the temperature regulating compartment in which the heat exchange plate 33 is provided is the cup holder inner space 75a, but this is an example. For example, the temperature regulating compartment may be an internal space of a storage compartment in which small articles, food, and the like are stored.
(4) In the first embodiment described above, as illustrated in FIGS. 1 and 2, the air heat exchanger 32 is a heat exchanger that cools the rear ventilation air Ab as a temperature regulation target, but this is an example. For example, as illustrated in FIG. 15, the air heat exchanger 32 may cool the temperature regulation target air Ac as a temperature regulation target blown to the temperature regulation space 77 described in the sixth embodiment, for example.
(5) In the sixth embodiment described above, as illustrated in FIGS. 9 and 10, the air heat exchanger 48 is a heat exchanger that warms the temperature regulation target air Ac as a temperature regulation target, but this is an example. For example, the air heat exchanger 48 may warm the rear ventilation air Ab (cf. FIG. 2) as a temperature regulation target.
(6) In the eighth embodiment described above, the first temperature regulation target heated by the first air heat exchanger 48 and the second temperature regulation target cooled by the second air heat exchanger 32 are the same, which is the temperature regulation target air Ac. However, this is an example. For example, the first temperature regulation target may be the temperature regulation target air Ac of FIG. 10, and the second temperature regulation target may be the rear ventilation air Ab of FIG. 2. The first temperature regulation target and the second temperature regulation target may not be the temperature regulation target air Ac.
(7) In the first embodiment described above, the first expansion valve 16 and the second expansion valve 20 illustrated in FIG. 1 are configured to be fully closable, but this is an example. For example, the first expansion valve 16 may not be fully closable, and an on-off valve may be provided in the refrigerant inlet 16a of the first expansion valve 16. Similarly, the second expansion valve 20 may not be fully closable, and an on-off valve may be provided in the refrigerant inlet 20a of the second expansion valve 20.
(8) The present disclosure is not limited to the embodiments described above, and various modifications can be made. The above embodiments are not unrelated to each other and can be appropriately combined unless the combination is obviously impossible.

It is understood that in each of the embodiments described above, the elements constituting the embodiment are not necessarily essential except for a case where it is explicitly stated that the elements are particularly essential and a case where the elements are considered to be obviously essential in principle. In the embodiments described above, when a numerical value such as the number, a numerical value, an amount, or a range of the constituent elements of the embodiment is mentioned, the numerical value is not limited to specific numerical values unless otherwise specified as being essential or obviously limited to the specific numerical values in principle. In each of the above embodiments, when the materials, shapes, positional relationships, and the like of the components and the like are referred to, the shapes, positional relationships, and the like are not limited thereto unless otherwise specified or limited to specific materials, shapes, positional relationships, and the like in principle.

The circuit controller 80 and the technique thereof described in the present disclosure may be implemented by a dedicated computer provided by constituting a processor and a memory programmed to execute one or more functions embodied by a computer program. Alternatively, the circuit controller 80 and the technique thereof described in the present disclosure may be implemented by a dedicated computer provided by constituting a processor with one or more dedicated hardware logic circuits. Alternatively, the circuit controller 80 and the technique thereof described in the present disclosure may be implemented by one or more dedicated computers configured by a combination of a processor and a memory programmed to execute one or more functions and a processor configured by one or more hardware logic circuits. The computer program may be stored in a computer-readable non-transitional tangible recording medium as an instruction to be executed by the computer.

What is claimed is:

1. A temperature regulating device for regulating a temperature of a temperature regulation target, the temperature regulating device comprising:
a refrigeration cycle including a compressor configured to compress a refrigerant, a refrigerant radiator configured to radiate heat from the refrigerant flowing out of the compressor, a first expansion valve configured to decompress the refrigerant flowing out of the refrigerant radiator, a first evaporator configured to evaporate the refrigerant flowing out of the first expansion valve and to cause the refrigerant to flow to the compressor, a second expansion valve configured to decompress the refrigerant flowing out of the refrigerant radiator, and a second evaporator configured to evaporate the refrigerant flowing out of the second expansion valve and to cause the refrigerant to flow to the compressor; and
a heat medium circuit that includes a heat exchange portion and in which a heat medium circulates while flowing through the heat exchange portion and the second evaporator, wherein
the first evaporator exchanges heat between the refrigerant and ventilation air blown to a space to be air conditioned, to evaporate the refrigerant and cool the ventilation air,
the second evaporator exchanges heat between the heat medium and the refrigerant, to evaporate the refrigerant and cool the heat medium, and
the heat exchange portion exchanges heat between the temperature regulation target and the heat medium, to cool the temperature regulation target.

2. The temperature regulating device according to claim 1, wherein
the refrigeration cycle includes a pressure adjustment valve, and
the pressure adjustment valve is provided on a refrigerant flow downstream side of the first evaporator and on a refrigerant flow upstream side of the compressor, to maintain a refrigerant pressure of the first evaporator at a predetermined value or more.

3. The temperature regulating device according to claim 1, wherein
the heat medium circuit includes a battery heat exchanger,
the heat medium flows through the battery heat exchanger in the heat medium circuit, and
the battery heat exchanger exchanges heat between a battery and the heat medium.

4. The temperature regulating device according to claim 1, further comprising
a fluid circuit that includes a battery heat exchanger, wherein
the refrigeration cycle includes a third expansion valve that decompresses the refrigerant flowing out of the refrigerant radiator, and a third evaporator that evaporates the refrigerant flowing out of the third expansion valve and causes the refrigerant to flow to the compressor,
in the fluid circuit, a battery cooling fluid circulates while flowing through the battery heat exchanger and the third evaporator,
the third evaporator exchanges heat between the battery cooling fluid and the refrigerant, to evaporate the refrigerant and cool the battery cooling fluid, and
the battery heat exchanger exchanges heat between the battery and the battery cooling fluid.

5. A temperature regulating device for regulating a temperature of a temperature regulation target, the temperature regulating device comprising:
a refrigeration cycle including a compressor configured to compress a refrigerant, a refrigerant radiator configured to radiate heat from the refrigerant flowing out of the compressor, an expansion valve configured to decompress the refrigerant flowing out of the refrigerant radiator, and an evaporator configured to evaporate the refrigerant flowing out of the expansion valve and to cause the refrigerant to flow to the compressor; and
a heat medium circuit that includes a heat exchange portion, a heat medium radiator, and a flow rate adjustment mechanism, and in which a heat medium circulates while flowing through the refrigerant radiator and at least one of the heat exchange portion or the heat medium radiator, wherein
the flow rate adjustment mechanism adjusts a flow rate ratio between a flow rate of the heat medium flowing through the heat exchange portion and a flow rate of the heat medium flowing through the heat medium radiator,
the evaporator exchanges heat between the refrigerant and ventilation air blown to the space to be air conditioned, to evaporate the refrigerant and cool the ventilation air,
the refrigerant radiator exchanges heat between the heat medium and the refrigerant, to heat the heat medium,
the heat medium radiator radiates heat from the heat medium, and
the heat exchange portion exchanges heat between the temperature regulation target and the heat medium, to heat the temperature regulation target.

6. The temperature regulating device according to claim 1, further comprising
a first heat medium circuit that includes a first heat exchange portion, a heat medium radiator, and a flow rate adjustment mechanism, and in which a first heat medium circulates while flowing through the refrigerant radiator and at least one of the first heat exchange portion or the heat medium radiator, wherein
the flow rate adjustment mechanism adjusts a flow rate ratio between a flow rate of the first heat medium flowing through the first heat exchange portion and a flow rate of the first heat medium flowing through the heat medium radiator,
the refrigerant radiator exchanges heat between the first heat medium and the refrigerant, to heat the first heat medium,
the heat medium radiator radiates heat from the first heat medium,
the first heat exchange portion exchanges heat between the temperature regulation target and the first heat medium, to heat the temperature regulation target,
the heat medium circuit is a second heat medium circuit,
the heat medium is a second heat medium,
the heat exchange portion is a second heat exchange portion,
the refrigeration cycle is configured to be capable of stopping a flow of the refrigerant flowing from the refrigerant radiator to the second evaporator,
when the flow rate adjustment mechanism allows the first heat medium to flow to the first heat exchange portion, the refrigerant flows from the refrigerant radiator to the first evaporator in the refrigeration cycle while the refrigerant is prevented from flowing from the refrigerant radiator to the second evaporator, and
when the refrigerant in the refrigeration cycle flows from the refrigerant radiator to the second evaporator, the flow rate adjustment mechanism allows the first heat medium to flow to the heat medium radiator while preventing the first heat medium from flowing to the first heat exchange portion.

7. The temperature regulating device according to claim 6, wherein the first heat exchange portion and the second heat exchange portion are formed integrally.

8. The temperature regulating device according to claim 1, wherein the heat medium circuit includes a pump that circulates the heat medium in the heat medium circuit, to increase or decrease the flow rate of the heat medium.

9. The temperature regulating device according to claim 1, wherein
the temperature regulating device is provided in a vehicle,
the temperature regulation target is air to be blown to a temperature regulation space that is separated from an outside of the vehicle and provided within the vehicle, and
the heat exchange portion exchanges heat between the heat medium and the temperature regulation target passing through the heat exchange portion.

10. The temperature regulating device according to claim 9, wherein
the space to be air conditioned is included in a vehicle interior space in which an occupant seat is disposed, and
the temperature regulation space is a space that occupies a part of the vehicle interior space and differs from the space to be air conditioned, or a space located around the vehicle interior space.
